(19) United States
(12) Patent Application Publication
(10) Pub. No.: US 2023/0066560 A1
(43) Pub. Date: Mar. 2, 2023

(54) AIRCRAFT WITH STRUCTURAL GAP FILLER

(71) Applicant: The Boeing Company, Chicago, IL (US)

(72) Inventors: Richard Dean Widdle, Carnation, WA (US); Daniel James Cowan, North Charleston, SC (US); Shane Edward Arthur, Kirkland, WA (US); Marianne Elizabeth Wilkinson, Redmond, WA (US); Jenna Kristin Pang, Renton, WA (US)

(21) Appl. No.: 18/046,882

(22) Filed: Oct. 14, 2022

Related U.S. Application Data
(63) Continuation-in-part of application No. 17/475,066, filed on Sep. 14, 2021.
(60) Provisional application No. 63/124,303, filed on Dec. 11, 2020.

(51) Int. Cl. B64C 3/34; B64C 3/26; B64C 3/36; B64F 5/10

(52) U.S. Cl. CPC B64C 3/34; B64C 3/26; B64C 3/36; B64F 5/10

(57) ABSTRACT

Fuel tanks and methods of manufacture are presented. A fuel tank in a wing of an aircraft comprises a composite skin, a composite spar, and a structural gap filler between a flange of the spar and a first surface of the skin, the structural gap filler having a compressive strength equivalent to or greater than a compressive strength of a joint between the composite spar and the composite skin.

### RELATED APPLICATION

The present application is a Continuation-in-Part of U.S. Pat. Application No. 17/475,066, filed on Sep. 14, 2021, entitled “LIQUID SHIM INJECTION DEVICES AND METHODS FOR INJECTING LIQUID SHIM MATERIAL BETWEEN ADJACENT COMPONENTS,” which is a non-provisional of and claims priority to U.S. Provisional Pat. Application No. 63/124,303, filed on Dec. 11, 2020, entitled “LIQUID SHIM INJECTION DEVICES AND METHODS FOR INJECTING LIQUID SHIM MATERIAL BETWEEN ADJACENT COMPONENTS,” the complete disclosure of both of which are incorporated herein by reference.

### BACKGROUND

### 1. Field

The present disclosure relates generally to manufacturing aircraft and more specifically to aircraft components with structural gap filler and methods of applying structural gap filler.

### 2. Background

Generally speaking, a shim is a material or a body that is used to fill a gap that separates adjacent components of an assembly or a structure. In particular, shims may be utilized to mitigate weaknesses caused by gaps separating adjacent components that are mechanically fastened to one another. A shim may include a variety of materials and configurations depending on the particular application. As examples, a shim may include a solid shim such as an insert, a washer, or a sheet that is inserted or otherwise positioned in the gap between the adjacent components. A shim also may include liquid shim material that is utilized to fill the gap, and in some instances, the liquid shim material is hardened to form a solid shim.

During construction of the assembly, a solid shim often is inserted into the gap after the adjacent components have been positioned relative to one another, which can require access to a spatially confined area when the gap is obscured by one or more of the adjacent components or other portions of the assembly. When liquid shim materials are used, the liquid shim material frequently is applied to either or both of the adjacent components before the adjacent components are positioned relative to one another. Generally, an excess of liquid shim material generally is applied, such that when the adjacent components are positioned relative to one another, the liquid shim material fills the gap and any excess liquid shim material is squeezed out from between the adjacent components. Often, the excess liquid shim material must be removed from the assembly once the adjacent components are positioned, which again can require access to a spatially confined space.

Moreover, liquid shim materials often must be carefully selected to possess a particular viscosity and/or handling time such that the liquid shim materials may flow once the adjacent components are brought together, remain localized to the applied area after being applied, and/or will not harden undesirably before the adjacent components are brought together. Thus, a need exists for improved devices and methods for applying liquid shim material to gaps between adjacent components of assemblies that may not require access to spatially confined spaces and/or may permit the liquid shim material to be applied after the adjacent components are positioned relative to one another.

Therefore, it would be desirable to have a method and apparatus that takes into account at least some of the issues discussed above, as well as other possible issues.

### SUMMARY

An embodiment of the present disclosure provides a fuel tank in a wing of an aircraft. The fuel tank comprises a composite skin, a composite spar, and a structural gap filler between a flange of the spar and a first surface of the skin. The structural gap filler has a compressive strength equivalent to or greater than a compressive strength of a joint between the composite spar and the composite skin.

Another embodiment of the present disclosure provides an aircraft. The aircraft comprises a first component, a second component, and a structural gap filler between a first surface of the first component and a second surface of the second component. The structural gap filler has a compressive strength equivalent to or greater than a compressive strength of a joint between the first component and the second component.

An embodiment of the present disclosure provides a method of forming a fuel tank in a wing of an aircraft. A structural gap filler is spread onto one of a first surface of a skin or a second surface of a second component. The structural gap filler is configured to provide compressive strength equivalent to the compressive strength of a joint between the skin and the second component. The skin is applied over the second component.

An embodiment of the present disclosure provides a method of forming a joint in an aircraft. A structural gap filler is spread onto at least one of a first surface of a first component or a second surface of a second component. The first component is applied over the second component. It is determined if there is a gap present between the structural gap filler and at least one of the first component or the second component. Additional structural gap filler is injected between the first component and second component when a gap is present between the structural gap filler and at least one of the first component or the second component.

An embodiment of the present disclosure provides a method of forming an aircraft. A structural gap filler is spread onto at least one of a first surface of a composite skin, flanges of spars, or edges of ribs. The composite skin is applied over the spars and the ribs. The structural gap filler is cured.

An embodiment of the present disclosure provides a method of filling a gap in an aircraft. It is determined if there is a gap of equal to or greater than 0.005" present between a first component and a second component. Structural gap filler is injected between the first component and second component when the gap of equal to or greater than 0.005" is present between the first component and the second component. The structural gap filler has a compressive strength equivalent to or greater than a compressive strength of a joint between the first component and the second component.

An embodiment of the present disclosure provides a fuel tank of an aircraft. The fuel tank comprises a composite skin having a first surface facing a composite spar and a composite rib, the composite spar, the composite rib, and a structural gap filler between the first surface of the skin and a flange of the spar and between the first surface of the skin and at least one shear tie of the composite rib. The structural gap filler has a compressive strength equivalent to or greater than a compressive strength of the joint between the composite spar and the composite skin.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is schematic illustration representing examples of liquid shim injection devices according to the present disclosure.

FIG. 2 is a schematic cross-sectional view representing more specific examples of the liquid shim injection devices of FIG. 1.

FIG. 3 illustrates the examples of liquid shim injection devices of FIG. 2 flowing liquid shim material into a gap between adjacent components of an assembly.

FIG. 4 is an isometric cutaway view of a portion of a wing box of an aircraft where the device shown in FIGS. 1-3 can be used.

FIG. 5 is a flowchart schematically representing examples of methods of injecting liquid shim material into a gap between adjacent components using the device shown in FIGS. 1-3.

FIG. 6 is an illustration of an aircraft in which an illustrative embodiment may be implemented;

FIG. 7 is an illustration of a block diagram of a manufacturing environment in which an illustrative embodiment may be implemented;

FIG. 8 is an illustration of an isometric view of a fuel tank of an aircraft in accordance with an illustrative embodiment;

FIG. 9 is an illustration of a partially exploded view of a fuel tank of an aircraft in accordance with an illustrative embodiment;

FIG. 10 is an illustration of a side view of a fuel tank of an aircraft in accordance with an illustrative embodiment;

FIG. 11 is an illustration of a side view of a portion of a fuel tank of an aircraft in accordance with an illustrative embodiment;

FIG. 12 is a flowchart of a method of forming a fuel tank in a wing of an aircraft in accordance with an illustrative embodiment;

FIG. 13 is a flowchart of a method of forming a joint in an aircraft in accordance with an illustrative embodiment;

FIG. 14 is a flowchart of a method of forming an aircraft in accordance with an illustrative embodiment;

FIG. 15 is a flowchart of a method of filling a gap in an aircraft in accordance with an illustrative embodiment;

FIG. 16 is an illustration of an aircraft manufacturing and service method in a form of a block diagram in accordance with an illustrative embodiment; and

FIG. 17 is an illustration of an aircraft in a form of a block diagram in which an illustrative embodiment may be implemented.

### DETAILED DESCRIPTION

The illustrative examples recognize and take into account one or more different considerations. The illustrative examples recognize and take into account that currently fuel leak prevention from carbon fiber fuel tanks involves a few steps. The illustrative examples recognize and take into account that currently gaps between composite components are filled with cured carbon fiber or fiberglass shimming material. The illustrative examples recognize and take into account that the shimming material is machined to the exacting dimensions of each gap. The illustrative examples recognize and take into account that this machining can take multiple iterations.

The illustrative examples recognize and take into account that after shimming, then polysulfide sealant is used to fay seal between the members, and after fastening a fillet seal is added along the edges. The illustrative examples recognize and take into account that these shimming and sealing steps add significant flow time and labor to the airplane build process.

The illustrative examples recognize and take into account that for a thin wing, reach restrictions make it undesirably difficult to get into the tank to measure or place shims as well as to place sealant.

The illustrative examples recognize and take into account that sealants have previously been used in manufacturing. However, the illustrative examples also recognize and take into account that sealants currently available do not provide the compressive strength that is desired in a joint.

The illustrative examples provide a structural gap filler that reduces manufacturing time and manufacturing steps. Structural gap filler provides structural loading and leak protection. The illustrative examples provide a structural gap filler that can be applied between components to fill a gap and meet the structural compression requirements of the joint.

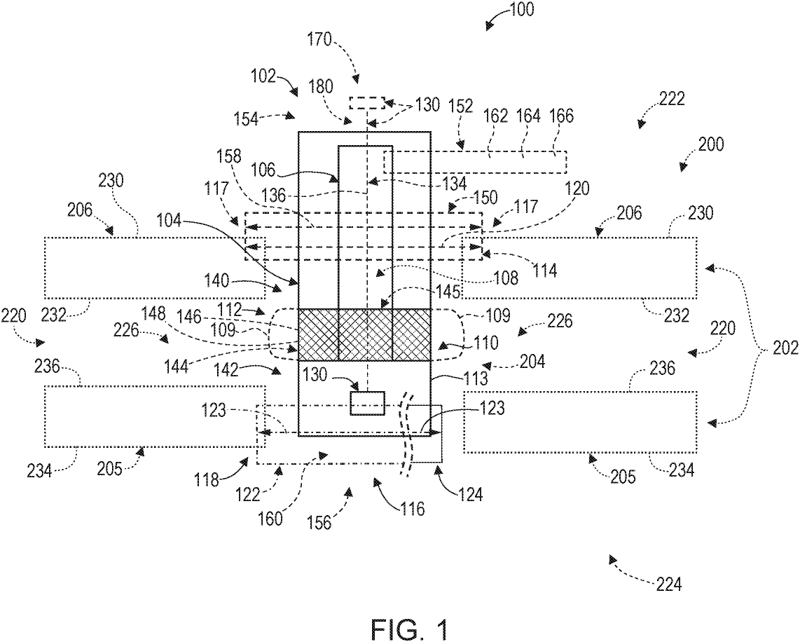

FIGS. 1-5 provide examples of liquid shim injection devices 100, assemblies 200 including a gap between adjacent components where liquid shim injection devices 100 may inject liquid shim material, and methods 500 for injecting liquid shim material into a gap between adjacent components of an assembly, according to the present disclosure.

Generally, in the figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a particular example without departing from the scope of the present disclosure. Additionally, in the figures, environment, or environmental structures may be illustrated in dotted lines to indicate that these structures, elements, or components are not included in, do not form portions of, or are environment to liquid shim injection devices 100. Dash-dot lines may be utilized in the figures to illustrate alternative configurations, conformations, positions, and/or orientations of a given element, structure, and/or assembly of liquid shim injection devices 100, and the configurations, conformations, positions, or orientations illustrated in dash-dot lines may be, but are not necessarily, optional conformations, positions, or orientations to liquid shim injection devices 100.

With initial reference to FIG. 1, illustrated therein is a schematic representation of examples of liquid shim injection devices 100 according to the present disclosure. As shown, liquid shim injection devices 100 comprise a body 102 that comprises an injection shaft 104 and a liquid shim conduit 106. Liquid shim conduit 106 is defined within body 102 and is configured to channel a liquid shim material 108 within injection shaft 104. Body 102 also includes a fluid-permeable region 110 formed along injection shaft 104 that is configured to provide fluid communication between liquid shim conduit 106 and an exterior 112 to, or the outside of, injection shaft 104.

Liquid shim injection devices 100 further include an actuated fluid seal 116 that is operably coupled to injection shaft 104 and configured to be selectively transitioned among a plurality of conformations. In particular, the plurality of conformations of actuated fluid seal 116 includes a sealing conformation 122 and a translation conformation 124. Actuated fluid seal 116 has an outermost lateral seal-dimension 123, such as the diameter of the actuated fluid seal 116 and/or the furthest extent of actuated fluid seal 116 transverse or perpendicular to a length of injection shaft 104. Outermost lateral seal-dimension 123 is greater when actuated fluid seal 116 is in sealing conformation 122 than when actuated fluid seal 116 is in translation conformation 124. In other words, actuated fluid seal 116 has an outermost lateral seal-dimension 123 that is greater in the sealing conformation 122 than in the translation conformation 124, and actuated fluid seal 116 is configured to be transitioned between sealing conformation 122 and translation conformation 124 to change outermost lateral seal-dimension 123. Sealing conformation 122 is shown in dash-dot lines in FIG. 1, and translation conformation 124 is shown in solid lines in FIG. 1.

Liquid shim injection devices 100 further include a fluid seal actuator assembly 130 that is associated with actuated fluid seal 116 and configured to selectively and operably transition actuated fluid seal 116 among the plurality of conformations. Fluid seal actuator assembly 130 additionally or alternatively may be described as being configured to actuate actuated fluid seal 116. More specifically, fluid seal actuator assembly 130 is configured to selectively and operably transition actuated fluid seal 116 between and/or among sealing conformation 122 and translation conformation 124. In some examples, liquid shim injection device 100 further includes a fluid barrier 114 that is operably coupled to body 102 and configured to form a flow barrier, for example, with an exterior component 206, such as discussed in more detail herein.

Liquid shim injection devices 100 may be described as defining a proximal portion 140 and a distal portion 142 that are separated from one another by fluid-permeable region 110. Actuated fluid seal 116 is positioned within and/or forms a portion of distal portion 142, and when included, fluid barrier 114 is positioned within and/or forms a portion of proximal portion 140. Stated differently, in some examples, fluid-permeable region 110 is positioned between fluid barrier 114 and actuated fluid seal 116.

In some examples, fluid-permeable region 110 is configured to extrude liquid shim material 108 in an outward direction from injection shaft 104 and/or towards exterior 112 to, or the outside of, injection shaft 104. Actuated fluid seal 116 is configured to at least partially confine, direct, or guide an extruded liquid shim material 109 that is extruded from fluid-permeable region 110, at least when actuated fluid seal 116 is in sealing conformation 122. When liquid shim injection devices 100 include fluid barrier 114, actuated fluid seal 116 and fluid barrier 114 are configured to confine extruded liquid shim material 109 to within a defined region exterior to injection shaft 104.

For example, as shown in FIG. 1, in some examples, liquid shim injection devices 100 are configured to inject liquid shim material 108 into a gap 220 between adjacent components 202 of an assembly 200. In some such examples, assembly 200 includes a bore 204 that extends through adjacent components 202, and injection shaft 104 is configured to be inserted into bore 204. More specifically, in some examples, assembly 200 defines an exterior region 222 and an interior region 224 that are separated from one another by adjacent components 202. In some examples, injection shaft 104 of liquid shim injection devices 100 is configured to be inserted into, or operably positioned within, bore 204 from exterior region 222.

Adjacent components 202 may include an exterior component 206 that is positioned proximate exterior region 222, and an interior component 205 that is positioned proximate interior region 224 and/or closer to interior region 224 than exterior component 206. In some examples, bore 204 extends through exterior component 206 and interior component 205, such that bore 204 extends between exterior region 222 and interior region 224. In some examples, adjacent components 202 of assembly 200 are components that are to be joined by a fastener, in which the fastener may be inserted through bore 204 and engaged with interior component 205 and exterior component 206 to mechanically fasten interior component 205 and exterior component 206 to one another. Examples of the fastener include one or more of a bolt, a screw, a nut, a peg, a ring, a gasket, an o-ring, a spacer, a washer, a rivet, a lockbolt, and/or combinations thereof. Adjacent components 202 may be constructed of any suitable material, depending on the application. As examples, adjacent components 202 are constructed of a metal, such as an aluminum or titanium alloy, a plastic material, and/or a composite material, such as a fiber reinforced plastic. Interior component 205 and exterior component 206 need not be constructed of the same material.

In some examples, it is desirable to fill gap 220 between adjacent components 202 with a structural shim, such as a hardened, solidified, set, and/or cured liquid shim material, to improve the strength of interior component 205 and/or exterior component 206 proximate bore 204, to prevent deformation of interior component 205 and/or exterior component 206 proximate bore 204, to improve load distribution or load transfer between interior component 205 and exterior component 206, and/or to reduce stress concentrations in the fastener, and/or in interior component 205 and/or exterior component 206 proximate bore 204, once interior component 205 and exterior component 206 are fastened to one another. Thus, in some examples, liquid shim injection devices 100 are configured to inject liquid shim material 108 into gap 220 to fill a region of gap 220 that surrounds bore 204 with extruded liquid shim material 109, which subsequently may be set, hardened, solidified, and/or cured to form a structural shim.

In some examples, liquid shim injection devices 100 are configured to fill an annular region 226 within gap 220 that surrounds bore 204. More specifically, in some examples, annular region 226 have an annular diameter, or outermost lateral extent, that corresponds to, is at least as large as, or larger than, a diameter of, or an outermost lateral extent of, an area of exterior component 206 and/or interior component 205 that is engaged or contacted by the fastener. As an example, the area of exterior component 206 or interior component 205 that is engaged by the fastener corresponds to the contact area of a washer of the fastener that operably contacts an exterior-facing surface 230 of exterior component 206 and/or an interior-facing surface 234 of interior component 205. That said, in some examples, the annular region 226 or the region of gap 220 filled with extruded liquid shim material 109 by liquid shim injection device 100 are not be perfectly symmetrical or do not have a circular cross-section. The “diameter” of annular region 226 additionally or alternatively includes the outermost lateral extent of volumes having non-circular cross sections.

As shown in FIG. 1, in some examples, fluid-permeable region 110 is positioned along injection shaft 104 such that at least a portion of fluid-permeable region 110 is positioned within gap 220 when injection shaft 104 is positioned operably within bore 204. In some examples, actuated fluid seal 116 is configured to form a fluid seal 118 with interior component 205 when injection shaft 104 is positioned operably within bore 204. More specifically, in some examples, actuated fluid seal 116 is configured to form fluid seal 118 with interior component 205 when actuated fluid seal 116 is in the sealing conformation 122, and actuated fluid seal 116 is configured to be inserted through and/or translated within bore 204 when actuated fluid seal 116 is in translation conformation 124. Stated differently, when actuated fluid seal 116 is in translation conformation 124, injection shaft 104 may be inserted within, removed from within, and/or translated within bore 204. In some examples, actuated fluid seal 116 is operably coupled to injection shaft 104 such that at least a portion of actuated fluid seal 116 is positioned adjacent interior component 205 when injection shaft 104 is positioned operably within bore 204.

As discussed herein, injection shaft 104 being “positioned operably” within bore 204 may refer to one or more desired positions, or range of positions, in which liquid shim injection device 100 is positioned to inject liquid shim material 108 into gap 220 between adjacent components 202. In some examples, liquid shim injection device 100 is configured to flow liquid shim material 108 through fluid-permeable region 110 into gap 220 to inject, deposit, or fill at least a region of gap 220 that surrounds bore 204 with extruded liquid shim material 109. When actuated fluid seal 116 is in sealing conformation 122, actuated fluid seal 116 may form fluid seal 118 with interior component 205 that confines extruded liquid shim material 109 to within gap 220, prevents extruded liquid shim material 109 from flowing to within bore 204 formed in interior component 205, and/or prevents extruded liquid shim material 109 from flowing to interior region 224. Similarly, in examples when liquid shim injection devices 100 include fluid barrier 114, fluid barrier 114 is configured to form a flow barrier 117 with exterior component 206, and flow barrier 117 may confine extruded liquid shim material 109 within gap 220, prevent extruded liquid shim material 109 from flowing to within bore 204 formed in exterior component 206, and/or prevent extruded liquid shim material 109 from flowing to exterior region 222.

As discussed in more detail herein, in some examples, exterior region 222 is physically more accessible and/or less physically constrained to access than interior region 224. With this in mind, exterior region 222 additionally or alternatively may be referred to as accessible region 222 and interior region 224 additionally or alternatively may be referred to as inaccessible region 224. In some examples, exterior component 206 is physically more accessible than interior component 205. In particular, in some examples, exterior component 206 obscures, blocks, and/or at least partially partitions interior component 205 and/or gap 220 from being accessed from exterior region 222, with the exception of accessing interior component 205 and/or gap 220 from exterior region 222 via bore 204. Thus, exterior component 206 additionally or alternatively may be referred to herein as accessible component 206, interior component 205 additionally or alternatively may be referred to as inaccessible component 205, and gap 220 additionally or alternatively may be referred to as inaccessible gap 220. In view of the above, liquid shim injection device 100 may be described as being configured to form fluid seal 118 with inaccessible component 205 from accessible region 222 and/or as being configured to flow liquid shim material 108 into inaccessible gap 220 from accessible region 222.

Adjacent components 202 additionally or alternatively includes more than two components, which may be arranged in any suitable manner and/or orientation relative to one another. In some examples, adjacent components 202 includes one or more components that are positioned within gap 220. Additionally or alternatively, exterior component 206 and/or interior component 205 are comprised of a plurality of subcomponents and/or portions, with additional gaps optionally being formed between them. In some examples, adjacent components 202 includes a plurality of interior components 205 that are separated from one another by a plurality of corresponding gaps 220, and bore 204 extends through exterior component 206 and through the plurality of interior components 205. As examples, adjacent components 202 include at least 2, at least 3, at least 4, at least 5, and/or at most 6 interior components 205 and at least 1, at least 2, at least 3, at least 4, and/or at most 5 corresponding gaps 220 separate the interior components 205. In such examples, the interior component 205 positioned nearest exterior component 206 may be referred to as a first interior component or as an exterior-most interior component, and liquid shim injection devices 100 is configured to inject liquid shim material 108 into gap 220 separating exterior component 206 and the first interior component, as well as any suitable number of additional gaps that separate the first interior component from an additional interior component and/or two or more additional interior components from one another. In some such examples, actuated fluid seal 116 is configured to form a fluid seal 118 with the interior component that is positioned furthest from exterior component 206, and/or fluid-permeable region 110 extends along injection shaft 104 such as to provide fluid communication between liquid shim conduit 106 and the plurality of corresponding gaps 220.

With continued reference to FIG. 1, injection shaft 104 may comprise any suitable size and/or shape. In some examples, injection shaft 104 is an elongate member, in which the length of injection shaft 104 is greater than an outermost lateral shaft-dimension 113 of injection shaft 104. As more specific examples, injection shaft 104 is generally cylindrical and/or a polygonal prism, such as a rectangular or other prism. Outermost lateral shaft-dimension 113 is measured transverse, or perpendicular, to the length of injection shaft 104. For example, when injection shaft 104 comprises a cylindrical shape, outermost lateral shaft-dimension 113 of injection shaft 104 is the diameter of injection shaft 104. In some examples, outermost lateral shaft-dimension 113 is configured to closely correspond to and/or match the geometry of bore 204. In particular, in some examples outermost lateral shaft-dimension 113 is dimensioned to closely fit within bore 204. As more specific examples, outermost lateral shaft-dimension 113 is a threshold fraction of a corresponding inside dimension, such as an inside diameter, of bore 204, with examples of the threshold fraction including at least 70%, at least 80%, at least 90%, at least 95%, at least 98%, at least 99%, at most 95%, at most 99%, and/or less than 100%.

In some examples, outermost lateral seal-dimension 123 of actuated fluid seal 116 is greater than outermost lateral shaft-dimension 113 when actuated fluid seal 116 is in sealing conformation 122. In this way, when injection shaft 104 is positioned operably within bore 204, and actuated fluid seal 116 is in sealing conformation 122, actuated fluid seal 116 extends laterally beyond injection shaft 104 to form fluid seal 118 with interior component 205. Additionally or alternatively, in some examples, outermost lateral seal-dimension 123 of actuated fluid seal 116 is equal to, at least substantially equal to, and/or less than outermost lateral shaft-dimension 113 of injection shaft 104 when actuated fluid seal 116 is in translation conformation 124. In this way, injection shaft 104 may be translated within bore 204 when actuated fluid seal 116 is in translation conformation 124.

Actuated fluid seal 116 includes any suitable structure and/or combination of one or more materials that are configured to be transitioned among the plurality of conformations. As examples, actuated fluid seal 116 comprises one or more of a resilient body 160, a bladder, a resilient bladder, an elastomeric body, a fluid-resistant body, a smooth body, a non-porous body, and/or a flexible body. Examples of suitable materials that optionally are included in actuated fluid seal 116 include one or more of a plastic, a polymer, a polymeric material, a fluid-resistant material, a non-stick material, a chemically resistant material, a rubber, a synthetic rubber, a silicone, mylar, latex, nylon, polytetrafluoroethylene (PTFE), and/or neoprene. Actuated fluid seal 116 also may include any suitable shape, such as a tubular shape, a cylinder, a sphere, a spheroid, a polygonal prism, and/or combinations thereof. In some examples, the shape of actuated fluid seal 116, or a lateral cross-section thereof, is configured to match an internal shape of bore 204 in interior component 205.

Actuated fluid seal 116 also may be configured to be actuated and/or selectively transitioned among the plurality of conformations in any suitable manner. As examples, actuated fluid seal 116 is one or more of mechanically actuated, fluidly actuated, pneumatically actuated, hydraulically actuated, electrically actuated, magnetically actuated, and electro-magnetically actuated. Likewise, fluid seal actuator assembly 130 may actuate actuated fluid seal 116 via any suitable mechanism, such as one or more of mechanical actuation, fluid actuation, pneumatic actuation, hydraulic actuation, and/or electrical actuation. As more examples, actuated fluid seal 116 is configured to be transitioned among the plurality of conformations via one or more of deformation, compression, expansion, contraction, elongation, widening, narrowing, inflation and/or deflation. With this in mind, in some examples, fluid seal actuator assembly 130 is configured to deform, compress, expand, elongate, widen, narrow, inflate, and/or deflate actuated fluid seal 116 to selectively and operably transition actuated fluid seal 116 among the plurality of conformations and/or to selectively and operably change outermost lateral seal-dimension 123 of actuated fluid seal 116.

As a more specific example, when actuated fluid seal 116 includes resilient body 160, fluid seal actuator assembly 130 is configured to selectively deform resilient body 160 to selectively and operably transition actuated fluid seal 116 among the plurality of conformations. In particular, in some such examples, resilient body 160 defines outermost lateral seal-dimension 123, and resilient body 160 is configured to be selectively deformed to change the outermost lateral seal-dimension 123 of actuated fluid seal 116. Stated differently, in some examples, fluid seal actuator assembly 130 is configured to selectively deform resilient body 160 to selectively change outermost lateral seal-dimension 123 of actuated fluid seal 116.

In some examples, fluid seal actuator assembly 130 is configured to compress, or apply a compressive force to, actuated fluid seal 116 and/or resilient body 160 to transition actuated fluid seal 116 from translation conformation 124 to sealing conformation 122 and/or to increase outermost lateral seal-dimension 123. Additionally or alternatively, in some examples, fluid seal actuator assembly 130 is configured to elongate, or apply an elongating force to, actuated fluid seal 116 and/or resilient body 160 to transition actuated fluid seal 116 from sealing conformation 122 to translation conformation 124 and/or to decrease the outermost lateral seal-dimension 123. As another example, when actuated fluid seal 116 comprises a bladder and/or a resilient bladder, fluid seal actuator assembly 130 is configured to transition actuated fluid seal 116 from translation conformation 124 to sealing conformation 122 and/or increase outermost lateral seal-dimension 123 by flowing fluid, such as a gas or a liquid, into the bladder to expand the bladder, and is configured to transition actuated fluid seal 116 from sealing conformation 122 to translation conformation 124 and/or to decrease the outermost lateral seal-dimension 123 by flowing fluid from the bladder to contract or deflate the bladder.

Actuated fluid seal 116 may be configured to operably contact and/or form fluid seal 118 with any suitable portion, region, and/or surface of interior component 205 when injection shaft 104 is positioned operably within bore 204 and/or when actuated fluid seal 116 is in sealing conformation 122. As examples, actuated fluid seal 116 operably contacts and/or forms fluid seal 118 with interior-facing surface 234 of interior component 205, a portion of bore 204 that extends within interior component 205, and/or an interior component gap-facing surface 236 of interior component 205 that faces gap 220.

With continued reference to FIG. 1, fluid seal actuator assembly 130 may include any suitable type of actuator assembly and may actuate actuated fluid seal 116 in any suitable manner. As examples, fluid seal actuator assembly 130 includes a mechanical actuator assembly, a fluid actuator assembly, a pneumatic actuator assembly, a hydraulic actuator assembly, and/or an electrical actuator assembly. As more specific examples, pneumatic actuator assemblies and/or hydraulic actuator assemblies includes one or more pumps or pistons for flowing fluid to within and/or from within actuated fluid seal 116. As another example, electrical actuator assemblies include one or more solenoid assemblies that apply an actuating force to actuated fluid seal 116 responsive to receiving electrical power.

As shown in FIG. 1, liquid shim injection device 100 may be described as having a proximal end region 154 and an opposed distal end region 156. In some examples, at least a portion of fluid seal actuator assembly 130 or actuated fluid seal 116 defines or is positioned within distal end region 156. In some examples, fluid seal actuator assembly 130 is configured to permit actuation of actuated fluid seal 116 from proximal end region 154. More specifically, in some examples, fluid seal actuator assembly 130 comprises an actuator connecting member 134 that extends along injection shaft 104 from proximal end region 154 to actuated fluid seal 116 and is configured to transmit actuation stimulus from proximal end region 154 to actuated fluid seal 116.

The actuation stimulus transmitted by actuator connecting member 134 includes any suitable stimulus, force, or power to facilitate actuation of actuated fluid seal 116, with examples including electrical stimulus, mechanical stimulus, and/or fluid stimulus. As examples, actuator connecting member 134 includes at least one of a fluid conduit, an electrical power conduit, and a mechanical connection. As discussed in more detail herein, an example of a mechanical connection is an actuation rod 136 that is configured to transmit mechanical force and/or mechanical stimulus from proximal end region 154 to actuated fluid seal 116. As a more specific example, when fluid seal actuator assembly 130 includes one or more solenoid actuators, actuator connecting member 134 includes an electrical conduit that is configured to supply electrical power to the one or more solenoid actuators to actuate actuated fluid seal 116, such as discussed herein. When fluid seal actuator assembly 130 comprises a pneumatic actuator assembly or a hydraulic actuator assembly, in some examples, actuator connecting member 134 includes a fluid conduit that is configured to supply fluid to actuate actuated fluid seal 116, such as discussed herein.

As shown in FIG. 1, in some examples, proximal end region 154 is positioned within exterior region 222 when injection shaft 104 is positioned operably within bore 204. In such examples, fluid seal actuator assembly 130 and/or actuator connecting member 134permits actuation of actuated fluid seal 116 from exterior region 222.

In some examples, fluid seal actuator assembly 130 comprises an actuator retention mechanism 180 that is configured to selectively and operably retain actuated fluid seal 116 in a desired conformation, such as sealing conformation 122 and/or translation conformation 124. For example, when fluid seal actuator assembly 130 includes actuation rod 136, in some examples, actuator retention mechanism 180 are configured to selectively engage with actuation rod 136 to selectively and operably secure actuation rod 136 at a desired position relative to body 102, injection shaft 104, and/or actuated fluid seal 116. As examples, actuator retention mechanism 180 include one or more of a ratchet, a threaded bore that mates with threads on actuation rod 136, a pin, a hole, a hitch, a clip, a latch, a twist-lock, a bolt, a nut, and/or combinations thereof.

With continued reference to FIG. 1, when included, fluid barrier 114 includes any suitable structure forming a flow barrier. Examples of suitable fluid barrier 114 structures include a gasket, an o-ring, and/or a stopper. Fluid barrier 114 also may be constructed from any suitable one or more materials, such as any of the one or more same materials that are utilized to form actuated fluid seal 116, or one or more different materials such as a ceramic, graphite, or asbestos.

Fluid barrier 114 may be disposed along any suitable location or region of body 102. In some examples, fluid barrier 114 is operably coupled to a proximal region of injection shaft 104 and/or extends circumferentially about the perimeter of injection shaft 104. In this configuration, fluid barrier 114 possesses an outermost lateral barrier-dimension 120 that is greater than outermost lateral shaft-dimension 113. When injection shaft 104 is positioned operably within bore 204, fluid barrier 114 covers and/or at least partially fills, or plugs at least a portion of bore 204 within exterior component 206 and form flow barrier 117 therewith. That said, fluid barrier 114 may be configured to operably contact and form flow barrier 117 with any suitable portion or region of exterior component 206, such as exterior-facing surface 230 of exterior component 206 that faces exterior region 222, within bore 204 of exterior component 206, and/or an exterior component gap-facing surface 232 of exterior component 206 that faces gap 220.

As shown in FIG. 1, in some examples, body 102 includes a circumferential ledge 150 positioned proximate injection shaft 104 and within proximal portion 140 of liquid shim injection devices 100 and fluid barrier 114 is positioned along, or operably coupled along, an underside of, or a distal surface of, circumferential ledge 150. In such examples, circumferential ledge 150 additionally or alternatively may be referred to as circumferential flange 150 and/or circumferential collar 150 and includes an outermost lateral ledge-dimension 158 that is greater than outermost lateral shaft-dimension 113. Circumferential ledge 150 may include any suitable shape, such as circular shapes, or non-circular shapes. In particular, when fluid barrier 114 is positioned along the underside of circumferential ledge 150, in some examples, fluid barrier 114 includes a gasket and/or an o-ring that covers at least a portion of, or the entirety of, the underside surface of circumferential ledge 150, such that fluid barrier 114 extends circumferentially about a proximal end portion of injection shaft 104. In some such examples, fluid barrier 114 is configured to form flow barrier 117 with exterior-facing surface 230 of exterior component 206 in which flow barrier 117 surrounds the exterior rim or opening of bore 204.

In some examples, circumferential ledge 150 additionally or alternatively is configured to form a stop collar that engages with exterior component 206 when injection shaft 104 is inserted into bore 204 such as to position injection shaft 104 with a desired depth or extension within bore 204, to operably position fluid-permeable region 110 at a desired position within bore, such as proximate or at least partially within gap 220, and/or to operably position actuated fluid seal 116 at a desired position within bore 204, such as proximate interior component 205. In some examples, the longitudinal position (i.e., position along liquid shim injection device 100 from proximal end region 154 to distal end region 156) of circumferential ledge 150 is configured to be adjusted, such as to control the length of injection shaft 104, the longitudinal separation between actuated fluid seal 116 and circumferential ledge 150 and/or fluid barrier 114, and/or the longitudinal separation between circumferential ledge 150 and fluid-permeable region 110.

With continued reference to FIG. 1, in some examples, actuated fluid seal 116 is a first actuated fluid seal and fluid barrier 114 is or includes a second actuated fluid seal. In other words, fluid barrier 114 may include similar or at least substantially similar features, functions or components to those discussed herein for actuated fluid seal 116, while being positioned within proximal portion 140. More specifically, when fluid barrier 114 is or includes the second actuated fluid seal, fluid barrier 114 is configured to be selectively transitioned among a plurality of conformations that include a sealing conformation and a translation conformation, such as discussed herein. In some such examples, fluid seal actuator assembly 130 is configured to selectively transition fluid barrier 114 among the plurality of conformations and/or includes one or more actuators for actuating fluid barrier 114. Stated differently liquid shim injection devices 100 include a distal actuated fluid seal and a proximal fluid seal that are separated from one another by fluid-permeable region 110 when fluid barrier 114 is or includes an actuated fluid seal 116. For some examples in which fluid barrier 114 is or includes an actuated fluid seal 116, fluid barrier 114 is configured to form a fluid seal with exterior component 206 when fluid barrier 114 is in the sealing conformation.

As mentioned, fluid-permeable region 110 is formed along injection shaft 104 and is configured to provide fluid communication between liquid shim conduit 106 and exterior 112 to injection shaft 104. In some examples, fluid-permeable region 110 forms one or more passageways for liquid shim material 108 to flow from liquid shim conduit 106 to exterior 112 to injection shaft 104 or to a region outside of injection shaft 104. In some examples, fluid-permeable region 110 forms a fluid-permeable annulus about a perimeter of injection shaft 104 through which liquid shim material 108 may be flowed from liquid shim conduit 106 to exterior 112. In some such examples, such as when injection shaft 104 is cylindrical, or comprises a cylindrical shape, fluid-permeable region 110 forms a cylindrical annulus about injection shaft 104.

Fluid-permeable region 110 may include any suitable structure for providing fluid communication between liquid shim conduit 106 and exterior 112. In some examples, injection shaft 104 comprises a tubular sidewall that surrounds, or at least partially encloses, liquid shim conduit 106, and fluid-permeable region 110 includes a plurality of perforations, passageways, tubules, and/or conduits that extend through the tubular sidewall. Additionally or alternatively, in some examples, fluid-permeable region 110 includes a fluid-permeable structure, such as a mesh screen, an expanded metal screen, a porous body, such as a porous metal body or a porous ceramic body, that is operably coupled to, and interposes, proximal portion 140 and distal portion 142 of injection shaft 104.

In some examples, fluid-permeable region 110 is configured to flow, distribute, direct, and/or extrude liquid shim material 108 in a particular manner or direction. As an example, fluid-permeable region 110 is configured to extrude liquid shim material 108 in an outward direction from injection shaft 104, such as a radially outward direction, or in a direction that is generally traverse to, or perpendicular to, the length of injection shaft 104. Additionally or alternatively, in some examples, fluid-permeable region 110 is configured to flow or extrude liquid shim material 108 evenly about, or with respect to, the perimeter of injection shaft 104. As a more specific example, when injection shaft 104 and/or fluid-permeable region 110 are cylindrical, fluid-permeable region is configured to flow or extrude liquid shim material 108 in the outward direction evenly about the circumference of injection shaft 104 and/or the circumference of fluid-permeable region 110. Stated another way, in some examples, fluid-permeable region 110 is configured to extrude or flow liquid shim material 108 from liquid shim conduit 106 to fill an annular region 226 of gap 220 with extruded liquid shim material 109. Additionally or alternatively, in some examples, fluid-permeable region 110 is configured to flow liquid shim material 108 into gap 220 such that extruded liquid shim material 109 contacts exterior component gap-facing surface 232 and/or interior component gap-facing surface 236 of interior component 205.

In some examples, fluid-permeable region 110 is, or includes, an actuated fluid-permeable region 144 that comprises a flowing configuration 146 and a closed configuration 148, in which, actuated fluid-permeable region 144 is configured to provide fluid communication between liquid shim conduit 106 and exterior 112 in flowing configuration 146 and is configured to restrict fluid communication between liquid shim conduit 106 and exterior 112 in closed configuration 148. Stated differently, in some examples, actuated fluid-permeable region 144 is configured to permit the flow or extrusion of liquid shim material 108 from liquid shim conduit 106 to exterior 112 in flowing configuration 146 and is configured to restrict the flow or extrusion of liquid shim material 108 from liquid shim conduit 106 to exterior 112 in closed configuration 148.

For some examples in which fluid-permeable region 110 is, or includes, actuated fluid-permeable region 144, liquid shim injection device 100 further includes a fluid actuator assembly 145 that is configured to selectively and operably transition actuated fluid-permeable region 144 between flowing configuration 146 and closed configuration 148. As examples, fluid actuator assembly 145 may include at least one of one or more flow actuators, one or more actuated valves, and/or an actuated internal sheath that is disposed within liquid shim conduit 106 configured to selectively and operably translate to restrict and provide fluid communication between fluid-permeable region 110 and liquid shim conduit 106. In some examples, fluid actuator assembly 145 includes a fluid actuator connecting member that is configured to permit actuation of actuated fluid-permeable region 144 from proximal end region 154, such as discussed herein for fluid seal actuator assembly 130. As an example, actuated fluid-permeable region 144 may comprise concentric tubular portions with perforations that are aligned when actuated fluid-permeable region 144 is in the flowing configuration 146 and that are misaligned when actuated fluid-permeable region 144 is in the closed configuration 148. That is, one of the concentric tubular portions may be configured to rotate relative to the other one of the concentric tubular portions for selective alignment and misalignment of the perforations.

With continued reference to FIG. 1, in some examples, liquid shim injection devices 100 include a liquid shim delivery system 152 that is in fluid communication with liquid shim conduit 106 and configured to selectively and operably provide liquid shim material 108 to liquid shim conduit 106. More specifically, in some examples, liquid shim delivery system 152 is configured to selectively and operably flow liquid shim material 108 to liquid shim conduit 106 to selectively extrude or flow liquid shim material 108 from fluid-permeable region 110 to exterior 112. Stated differently, when injection shaft 104 is positioned operably within bore 204, in some examples, liquid shim delivery system 152 is configured to selectively and operably flow liquid shim material 108 to liquid shim conduit 106 to selectively extrude or flow liquid shim material 108 from fluid-permeable region 110 to within gap 220 to selectively inject or deposit extruded liquid shim material 109 within gap 220.

In some examples, liquid shim delivery system 152 is configured to selectively flow a predetermined volume of liquid shim material 108 through liquid shim conduit 106 to extrude the predetermined volume of liquid shim material 108 through fluid-permeable region 110. For example, when injection shaft 104 is positioned operably within bore 204, in some examples, liquid shim delivery system 152 is configured to selectively flow a predetermined volume of liquid shim material 108 through liquid shim conduit 106 to selectively deposit or inject a predetermined volume of extruded liquid shim material 109 within gap 220. More specifically, the predetermined volume of extruded liquid shim material 109 may correspond to an annular diameter or volume of annular region 226 surrounding bore 204 that is desired to be filled with liquid shim material 108. As examples, annular diameter of annular region 226 is a threshold fraction of the bore diameter of bore 204, with examples of the threshold fraction including at least 101% at least 105%, at least 110%, at least 120%, at least 150%, at least 200%, at most 150%, at most 200%, at most 300%, and/or at most 400%. Additionally or alternatively, the predetermined volume of extruded liquid shim material 109 may correspond to the height of gap 220 and/or the distance between exterior component 206 and interior component 205 proximate bore 204, examples of which include at least 25 micrometers, at least 50 micrometers, at least 75 micrometers, at least 100 micrometers, at least 200 micrometers, at most 75 micrometers, at most 100 micrometers, at most 100 micrometers, at most 200 micrometers, and/or at most 500 micrometers.

When included, liquid shim delivery system 152 comprises any suitable mechanism, actuator(s), and/or structure for operably providing liquid shim material 108 to liquid shim conduit 106. As examples, liquid shim delivery system 152 may comprise at least one of a pump 162 configured to pump, flow, or move liquid shim material 108, a liquid shim reservoir 164 configured to contain a volume of liquid shim material 108 and optionally gravity-feed liquid shim material 108, a valve system configured to control the flow of liquid shim material 108 to liquid shim conduit 106 and optionally meter the preselected volume of liquid shim material 108, and a liquid shim line 166 that is in fluid communication with an external source 168 of liquid shim material 108.

Liquid shim injection device 100 may be configured to handle, flow, and/or inject any suitable type of liquid shim material 108. Typically, liquid shim material 108 is selected to be compatible with the material of adjacent components 202, such as to prevent, restrict, or otherwise reduce corrosion or other structurally compromising effects and/or to enhance bonding between liquid shim material 108 and adjacent components 202. As more specific examples, liquid shim material 108 may include one or more of a curable liquid shim material, a hardening liquid shim material, a resin, an epoxy, an epoxy resin, a 2-part resin, an adhesive, an adhesive resin, a polymer, a polymeric material, and/or a curable composite material. In particular, in some examples, liquid shim material 108 is configured to be in a liquid or flowable state when liquid shim material 108 is within liquid shim delivery system 152, is within liquid shim conduit 106, passing through fluid-permeable region 110, and or injected into gap 220 as extruded liquid shim material 109, but may be configured to cure, harden, solidify, and/or set into a structural material after being extruded by liquid shim injection device 100. As such, liquid shim material 108 additionally or alternatively may be referred to as structural liquid shim material 108.

In some examples, liquid shim material 108 further is configured to bind to, or adhere to, interior component 205 and/or exterior component 206 once cured, hardened, or set within gap 220. For some examples in which liquid shim material 108 is configured to cure, set, or harden within gap 220, liquid shim injection device 100 includes a curing shaft that is operably coupled to, or defines a portion of, distal end region 156. Optionally, the curing shaft is configured to be decoupled from a remainder of liquid shim injection device 100 and left within bore 204 after extruded liquid shim material 109 has been deposited therein and/or after injection shaft 104 has been removed therefrom. In such examples, the curing shaft is configured to prevent extruded liquid shim material 109 from flowing into bore 204 while extruded liquid shim material 109 hardens, cures, or sets.

With continued reference to FIG. 1, liquid shim injection devices 100 are configured to be operated in any suitable manner. In some examples, liquid shim injection device 100 is configured as a handheld device, is a hand-operated device, and/or is configured to be operated by a human operator, such as trained or authorized personnel. Additionally or alternatively, liquid shim injection device 100 is configured to be mounted to, mounted with, or mounted as an end effector of a robotic arm 170 or other robotic device.

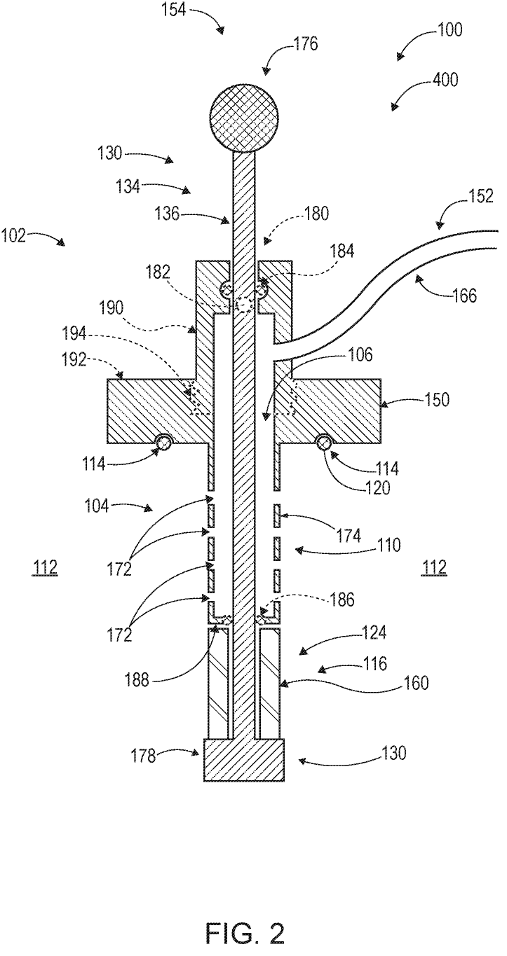

Turning now to FIGS. 2-4, illustrative non-exclusive examples of liquid shim injection devices 100 and assemblies 200 are illustrated. Where appropriate, the reference numerals from the schematic illustrations of FIG. 1 are used to designate corresponding parts of FIGS. 2-4; however, the examples of FIGS. 2-4 are non-exclusive and do not limit liquid shim injection devices 100 and assemblies 200 to the illustrated embodiments of FIGS. 2-4. That is, liquid shim injection devices 100 and assemblies 200 are not limited to the specific embodiments and/or specific applications illustrated in FIGS. 2-4, and liquid shim injection devices 100 and assemblies 200 may incorporate any number of the various aspects, configurations, characteristics, properties, etc. of liquid shim injection devices 100 and assemblies 200 that are illustrated in and discussed with reference to the schematic representations of FIG. 1 and/or the embodiments of FIGS. 2-4, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to FIGS. 2-4; however, it is within the scope of the present disclosure that the previously discussed features, variants, etc. may be utilized with the embodiments of FIGS. 2-4.

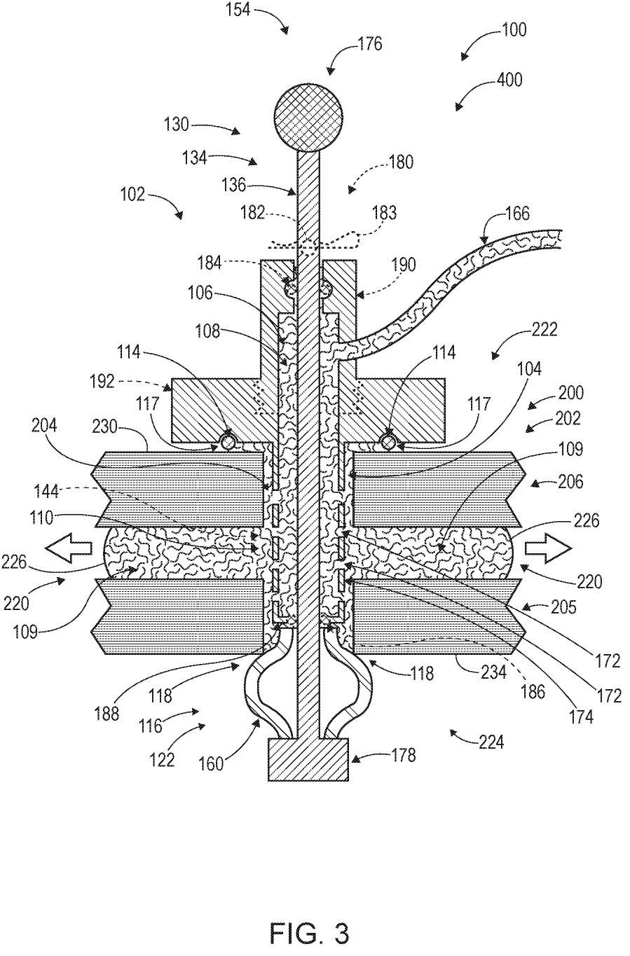

FIGS. 2 and 3 illustrate, in cross-section, examples of liquid shim injection devices 100, referred to herein as liquid shim injection devices 400. In FIG. 2, liquid shim injection devices 400 are represented with actuated fluid seal 116 in translation conformation 124, and in FIG. 3, liquid shim injection devices 400 are represented with actuated fluid seal 116 in sealing conformation 122 and extending through bore 204 of assembly 200. As shown, liquid shim injection devices 400 include body 102, which includes injection shaft 104 and liquid shim conduit 106, in which liquid shim conduit 106 is defined within body 102 and at least a portion of injection shaft 104. Body 102 also includes fluid-permeable region 110 formed along injection shaft 104 that is configured to provide fluid communication between liquid shim conduit 106 and exterior 112 to injection shaft 104. In the specific example of FIGS. 2 and 3, fluid-permeable region 110 comprises a plurality of perforations 172 that extend laterally through an injection shaft sidewall 174 of injection shaft 104, in which perforations 172 may be distributed evenly about the perimeter of injection shaft 104. Liquid shim injection devices 400 further include actuated fluid seal 116 operably coupled to injection shaft 104. More specifically, actuated fluid seal 116 is illustrated in translation conformation 124 and includes resilient body 160 that is formed in a tubular shape and operably coupled to an injection shaft distal end 188 of injection shaft 104.

Liquid shim injection devices 400 further include fluid seal actuator assembly 130 associated with actuated fluid seal 116 and configured to operably transition actuated fluid seal 116 among the plurality of conformations. More specifically, in these examples, fluid seal actuator assembly 130 is a mechanical actuator assembly. Fluid seal actuator assembly 130 includes actuator connecting member 134 that extends from proximal end region 154 to actuated fluid seal 116 and along injection shaft 104. In particular, actuator connecting member 134 comprises actuation rod 136 that extends through injection shaft 104 and is operably coupled to actuated fluid seal 116. Actuation rod 136 is configured to be selectively translated longitudinally within injection shaft 104 and relative to actuated fluid seal 116 to transition actuated fluid seal 116 among the plurality of conformations. More specifically, actuation rod 136 extends through the inside of resilient body 160 and is operably coupled to, or terminates as, a fluid seal seat 178, or fluid seal flange, that supports the distal end of actuated fluid seal 116 and defines distal end region 156 of liquid shim injection device 400. The other end of actuation rod 136, or an actuation rod proximal end region 176, defines proximal end region 154 of liquid shim injection devices 400.

Actuation rod proximal end region 176 is selectively translated relative to body 102 to selectively translate actuation rod 136 longitudinally within injection shaft 104 and/or relative to actuated fluid seal 116. When actuation rod proximal end region 176 is translated away from actuated fluid seal 116, fluid seal seat 178 compresses actuated fluid seal 116 and/or resilient body 160 against injection shaft distal end 188 to cause resilient body 160 and/or actuated fluid seal 116 to deform outwardly, and/or to cause the outermost lateral seal-dimension of actuated fluid seal 116 to increase. Stated differently, when actuation rod proximal end region 176 is translated away from actuated fluid seal 116, actuated fluid seal 116 transitions towards sealing conformation 122. When actuation rod proximal end region 176 is translated towards actuated fluid seal 116, fluid seal seat 178 may apply a smaller compressive force, or apply an elongating force, to actuated fluid seal 116 to cause actuated fluid seal 116 and/or resilient body 160 to deform inwardly, relax from outward deformation, and/or to cause the outermost lateral seal-dimension to decrease. In other words, when actuation rod proximal end region 176 is translated towards actuated fluid seal 116, actuated fluid seal 116 transitions towards translation conformation 124.

In some examples, actuated fluid seal 116 is formed, biased, and/or resting in sealing conformation 122. In such examples, actuated fluid seal 116 is formed such that actuated fluid seal 116 is in sealing conformation 122, or the outermost lateral seal-dimension 123 of actuated fluid seal 116 is largest, when actuation rod 136 does not apply an actuation force to actuated fluid seal 116, and is configured to transition from its resting, sealing conformation 122 to translation conformation 124 when actuation rod 136 applies an elongating force to actuated fluid seal 116. Stated differently, actuated fluid seal 116 and/or resilient body 160 applies a restoring force to fluid seal seat 178 and/or actuation rod 136 in translation conformation 124 when actuated fluid seal 116 is formed, biased, or resting in sealing conformation 122.

In other examples, actuated fluid seal 116 is formed, biased, and/or resting in translation conformation 124. In such examples, actuated fluid seal 116 is formed such that actuated fluid seal 116 is in translation conformation 124 when actuation rod 136 does not apply an actuation force to actuated fluid seal 116, and transitions to sealing conformation 122 when actuation rod 136 compresses or applies a compressive force to actuated fluid seal 116. Stated differently, actuated fluid seal 116 and/or resilient body 160 applies a restoring force to fluid seal seat 178 and/or actuation rod 136 in sealing conformation 122 when actuated fluid seal 116 is formed, biased, or resting in translation conformation 124.

In some examples of liquid shim injection devices 400, fluid seal actuator assembly 130 comprises actuator retention mechanism 180 that is configured to selectively and operably retain actuated fluid seal 116 in a desired conformation, such as sealing conformation 122 and/or translation conformation 124. More specifically, in the examples of FIGS. 2 and 3, actuator retention mechanism 180 is configured to selectively engage with actuation rod 136 to selectively and operably secure actuation rod 136 at a desired position relative to body 102, injection shaft 104, and/or actuated fluid seal 116. In the specific illustrated examples of liquid shim injection devices 400 in FIG. 2, actuated fluid seal 116 and/or resilient body 160 are resting in translation conformation 124 and/or not applying a restoring force to actuation rod 136. In some examples, actuator retention mechanism 180 comprises a retention bore 182 that is formed along actuation rod 136 and positioned within body 102 when actuated fluid seal 116 is in translation conformation 124. In such examples, and as illustrated in FIG. 3, retention bore 182 is exposed when actuation rod proximal end region 176 is translated away from actuated fluid seal 116, and actuation retention mechanism 180 includes a retention member 183, such as a pin, that is engaged with retention bore 182 to retain retention bore 182 outside of body 102 and/or to retain actuated fluid seal 116 in sealing conformation 122.

In some examples, actuation rod 136 extends within liquid shim conduit 106. In some such examples, liquid shim injection device 400 comprises a proximal rod seal 184 that is operably coupled to body 102 proximate a proximal end of liquid shim conduit 106. When included, proximal rod seal 184 is configured to form at least a partial fluid seal with actuation rod 136 to prevent liquid shim material 108 from exiting liquid shim conduit 106 through the bore in body 102 through which actuation rod 136 extends. Proximal rod seal 184 also is configured to permit actuation rod 136 to translate relative to proximal rod seal 184. Additionally or alternatively, liquid shim injection device 400 comprises a distal rod seal 186 that is operably coupled to injection shaft 104 proximate the distal end of liquid shim conduit 106 and configured to form at least a partial fluid seal with actuation rod 136 to prevent liquid shim material 108 from flowing from the distal end of liquid shim conduit 106. When included, distal rod seal 186 also is configured to permit actuation rod 136 to translate relative to distal rod seal 186. In other examples, actuation rod 136 extends within a conduit that extends through liquid shim conduit 106 and fluidly isolates liquid shim conduit 106 from actuation rod 136, while permitting actuation rod 136 to selectively translate relative to body 102.

Liquid shim injection devices 400 also include fluid barrier 114 and circumferential ledge 150, which forms a portion of body 102. As shown, fluid barrier 114 is disposed along an underside of circumferential ledge 150. The outermost lateral ledge-dimension 158 of circumferential ledge 150 and the outermost lateral barrier-dimension 120 of fluid barrier 114 are greater than the outermost lateral shaft-dimension 113 of injection shaft 104. Liquid shim injection devices 400 further include liquid shim delivery system 152 that is in fluid communication with liquid shim conduit 106. In the examples shown in FIGS. 2 and 3, liquid shim delivery system 152 comprises liquid shim line 166 that is fluid communication with an external source of liquid shim material 108.

In some examples, liquid shim injection devices 400 comprise one or more interconnecting segments that are configured to be selectively and repeatedly interconnected with, and disconnected from, one another to selectively adjust operation of liquid shim injection devices 400 without damage or destruction to liquid shim injection devices 400 and/or one or more components thereof. As shown optionally and schematically in FIGS. 2 and 3, body 102 comprises a head segment 190 and a barrel segment 192 that are operably coupled to one another via coupling interface 194. Head segment 190 encloses a first portion of liquid shim conduit 106 and is interconnected with liquid shim line 166, and actuation rod proximal end region 176 extends from the proximal end of head segment 190. Barrel segment 192 encloses a second portion of liquid shim conduit 106 and comprises injection shaft 104 and circumferential ledge 150. Coupling interface 194 interconnects head segment 190 and barrel segment 192 and is configured to permit head segment 190 and barrel segment 192 to be selectively and repeatedly interconnected with and disconnected from one another. In a specific example, coupling interface 194 comprises mating threaded portions disposed on head segment 190 and barrel segment 192.

In some examples, liquid shim injection devices 400 comprise a plurality of interchangeable barrel segments 192 that are interchanged to adjust various features of body 102, such that liquid shim injection device 400 may be utilized to inject liquid shim material 108 into assemblies 200 having gaps 220, bores 204, and/or adjacent components 202 of various sizes, shapes, and/or dimensions. As an example, each barrel segment 192 includes an injection shaft 104 having a particular length, a particular outermost lateral shaft dimension, and/or a particular position or area of fluid-permeable region 110 along injection shaft 104, such that each barrel segment 192 is utilized to inject liquid shim material 108 between adjacent components 202 of a particular dimension.

With reference to FIG. 3, bore 204 extends through adjacent components 202 from exterior region 222 to interior region 224, and injection shaft 104 is positioned operably within bore 204. In particular, injection shaft 104 is positioned operably within bore 204 such that actuated fluid seal 116 is positioned proximate interior component 205 and fluid barrier 114 operably contacts and forms flow barrier 117 with exterior-facing surface 230 of exterior component 206. Proximal end region 154 of liquid shim injection device 400 is within exterior region 222 defined by assembly 200 and fluid barrier 114 contacts exterior component 206 optionally acting as a stop collar that operably positions injection shaft 104 and/or actuated fluid seal 116 at a desired depth or extension within bore 204.

In FIG. 3, actuated fluid seal 116 is transitioned from translation conformation 124 shown in FIG. 2 to sealing conformation 122, in which the outermost lateral seal-dimension 123 of actuated fluid seal 116 is expanded, such that fluid seal 118 operably contacts, and forms fluid seal 118 with interior component 205. In FIG. 3, actuation rod proximal end region 176 of actuation rod 136 has been translated away from actuated fluid seal 116 and/or injection shaft 104 causing fluid seal seat 178 to compress actuated fluid seal 116 against injection shaft distal end 188, which causes actuated fluid seal 116 and/or resilient body 160 to deform outwardly and increase the outermost lateral seal-dimension 123.

With continued reference to FIG. 3, at least a portion of fluid-permeable region 110 is positioned within gap 220. Liquid shim line 166 flows liquid shim material 108 from an external source of liquid shim material 108 to liquid shim conduit 106 to cause liquid shim material 108 to flow through fluid-permeable region 110 to within gap 220. In other words, liquid shim injection device 400 deposits, extrudes, or injects extruded liquid shim material 109 to within gap 220. Actuated fluid seal 116 and fluid barrier 114 form a fluid-confining space that directs extruded liquid shim material 109 to be deposited within gap 220. In some examples, liquid shim injection device 400 fills annular region 226 of gap 220 that surrounds bore 204 with extruded liquid shim material 109. In some examples, liquid shim delivery system 152 delivers a predetermined volume of liquid shim material 108 to liquid shim conduit 106 to control the volume and/or annular diameter of annular region 226.

In some examples, a portion of extruded liquid shim material 109 is deposited within bore 204. In some such examples, extruded liquid shim material 109 that is deposited in bore 204 is removed from bore 204 by removing injection shaft 104 from within bore 204 while actuated fluid seal 116 is conformed such that the outermost lateral seal-dimension 123 of actuated fluid seal 116 closely corresponds to a diameter of bore 204. Alternatively, extruded liquid shim material 109 that is deposited in bore 204 is removed by drilling or reaming bore 204 after extruded liquid shim material 109 is solidified, hardened, set, or cured within bore 204, such as discussed in more detail herein.

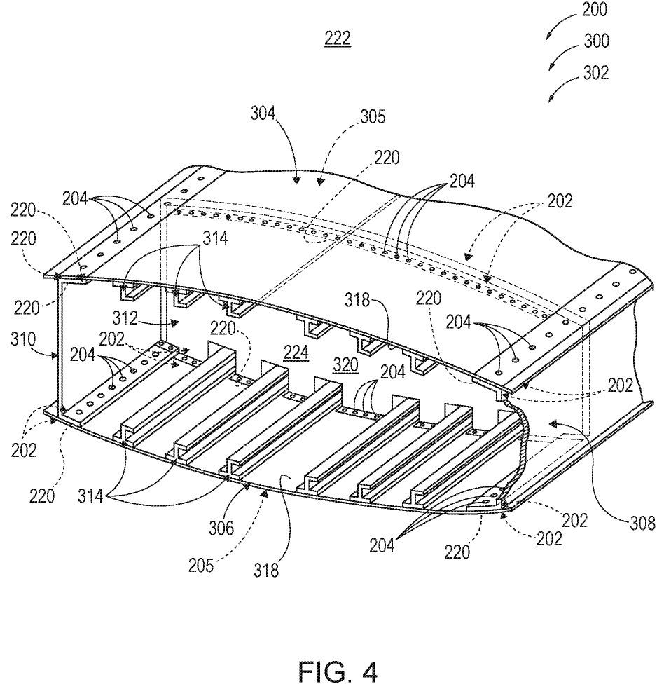

Turning to FIG. 4, illustrated therein is a more specific example of an assembly 200 where previously discussed liquid shim injection devices 100 of FIGS. 1-3 may be utilized. More specifically, FIG. 4 is an isometric cutaway view of a portion of a wing box 302 of an aircraft 300, and wing box 302 may be or include assembly 200 discussed herein with reference to FIGS. 1-3. As shown, wing box 302 is a three-dimensional structure surrounding and at least partially enclosing an interior space 320, which may be, or include interior region 224 of assembly 200. Wing box 302 may be comprised of a plurality of components including an upper wing panel 304, a lower wing panel 306, wing spars 308, 310, one or more ribs 312, and a plurality of stringers 314. In particular, wing spars 308, 310 extend between upper wing panel 304 and lower wing panel 306 and longitudinally along the length of wing box 302. Stringers 314 run generally parallel to wing spars 308, 310 along an interior surface 318 of upper wing panel 304 and an interior surface 318 of lower wing panel 306. While only one rib 312 is visible in FIG. 4, wing boxes 302 generally include a plurality of ribs 312 that may be spaced apart along the length of wing box 302.

A plurality of fasteners are utilized to secure upper wing panel 304 and lower wing panel 306 to wing spars 308, 310 and/or to ribs 312. More specifically, wing box 302 include a plurality of bores 204 extending between upper wing panel 304 and wing spars 308, 310 and/or ribs 312 and/or between lower wing panel 306 and wing spars 308, 310 and/or ribs 312, in which bores 204 may receive the fasteners. Further shown, interior surface 318 of upper wing panel 304 and/or interior surface 318 of lower wing panel 306 are separated from wing spars 308, 310 and/or ribs 312 by gap 220. As discussed herein, in some examples, it is desirable to fill gap 220 with liquid shim material 108. It particularly may be desirable to fill gap 220 when one or more components of wing box 302 are formed from composite and/or non-metallic materials. Thus, liquid shim injection devices 100 according to the present disclosure may be utilized to inject liquid shim material 108 into any of the gaps 220 of wing box 302 that are shown in FIG. 4. In a specific example, liquid shim injection devices 100 discussed herein with reference to FIGS. 1-3 are configured to form fluid seal 118 with at least one of rib 312 and wing spars 308, 310, optionally form fluid barrier 114 with at least one of upper wing panel 304 and lower wing panel 306, and inject liquid shim material 108 into gap 220 between upper wing panel 304 and ribs 312, gap 220 between upper wing panel 304 and wing spars 308, 310, gap 220 between lower wing panel 306 and ribs 312, and/or gap 220 between lower wing panel 306 and wing spars 308, 310.

In the above example, upper wing panel 304 and lower wing panel 306 each define an exterior component 206 while any of rib 312, stringers 314 and/or wing spars 308, 310 each define an interior component 205. In other words, upper wing panel 304 and any of rib 312, stringers 314, and/or wing spars 308, 310 may comprise adjacent components 202 discussed herein and/or lower wing panel 306 and any of rib 312, stringers 314 and/or wing spars 308, 310 may comprise adjacent components 202. Adjacent components 202 at least partially partition exterior region 222 from interior region 224, such that access to ribs 312 and/or stringers 314 and/or interior region 224 from exterior region 222 may be limited. As discussed herein, liquid shim injection devices 100 according to the present disclosure may be configured to inject liquid shim material 108 into gaps 220 of wing box 302 from exterior region 222 and/or without requiring access to interior region 224 and/or interior space 320 of wing box 302.

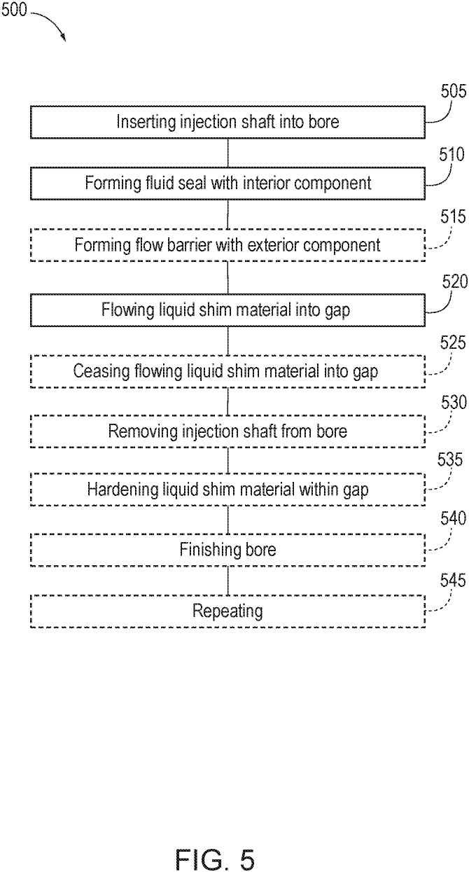

FIG. 5 schematically provides a flowchart that represents illustrative, non-exclusive examples of methods 500 for injecting a liquid shim material into a gap between adjacent components of an assembly according to the present disclosure. In FIG. 5, some steps are illustrated in dashed boxes indicating that such steps may be optional or may correspond to an optional version of a method according to the present disclosure. That said, not all methods according to the present disclosure are required to include the steps illustrated in solid boxes. The methods and steps illustrated in FIG. 5 are not limiting and other methods and steps are within the scope of the present disclosure, including methods having greater than or fewer than the number of steps illustrated, as understood from the discussions herein. Additionally, methods 500 are not limited to the sequence of steps that are illustrated in FIG. 5, and the steps of methods 500 may be performed in any suitable sequence or order without departing from the scope of the present disclosure.

Methods 500 presented in FIG. 5 may be performed utilizing liquid shim injection device 100 and/or with assemblies 200 that are discussed herein with reference to FIGS. 1-4. Stated differently, the liquid shim injection device 100 discussed herein with reference to FIG. 5 and methods 500 may include any of the features, functions, components, attributes, aspects, characteristics, properties, etc. of liquid shim injection device 100 that are discussed herein with reference to FIGS. 1-4, without requiring inclusion of all such features, functions, components, attributes, aspects, characteristics, properties, etc. Similarly, the assemblies 200 with which methods 500 are performed may be assemblies 200 illustrated and discussed herein with reference to FIGS. 1-4 and/or may include may include any of the features, functions, components, attributes, aspects, characteristics, properties, etc. of assemblies 200 that are discussed herein with reference to FIGS. 1-4 without requiring inclusion of all such features, functions, components, attributes, aspects, characteristics, properties, etc. Likewise, liquid shim injection device 100 discussed herein with reference to FIGS. 1-4 may include any the features, functions, components, attributes, aspects, characteristics, properties, etc. of the liquid shim injection device 100 discussed herein with reference to FIG. 5 and methods 500 without requiring inclusion of all such features, functions, components, attributes, aspects, characteristics, properties, etc. and/or may be configured to perform any of the steps and/or functions discussed herein with reference to methods 500 without being required to be configured to perform all such steps and/or functions.

As shown in FIG. 5, methods 500 include inserting 505 an injection shaft 104 of a liquid shim injection device 100 into a bore 204 that extends through adjacent components 202 of an assembly 200, forming a fluid seal 118 between the liquid shim injection device 100 and an interior component 205 of the adjacent components 202 at 510, and flowing 520 the liquid shim material 108 from the liquid shim injection device 100 into the gap 220 that separates the adjacent components 202. Methods 500 optionally include forming 515 a fluid barrier 114 between the liquid shim injection device 100 and an exterior component 206 of the adjacent components 202, ceasing 525 the flowing the liquid shim material 108 into the gap 220, removing 530 the injection shaft 104 from the bore 204, hardening 535 the liquid shim material 108 within the gap 220, finishing 540 the bore 204, and/or repeating 545.

Inserting 505 the injection shaft 104 into the bore 204 additionally or alternatively may be referred to as operably positioning the injection shaft 104 within the bore 204, such as discussed herein. More specifically, in some examples, the inserting 505 the injection shaft 104 into the bore 204 includes positioning an actuated fluid seal 116 of the liquid shim injection device 100 proximate the interior component 205 of the adjacent components 202 and/or positioning at least a portion of a fluid-permeable region 110 of the injection shaft 104 within or proximate the gap 220. As another example, the inserting 505 optionally includes positioning a fluid barrier 114 of the liquid shim injection device 100 proximate and/or in contact with the exterior component 206 of the adjacent components 202. In some examples, the inserting 505 comprises maintaining the actuated fluid seal 116 in a translation conformation 124 during the inserting 505, such as discussed herein.

As discussed herein, in some examples, the assembly 200 and/or the adjacent components 202 defines an exterior region 222 and an interior region 224 that are at least partially separated from one another by the adjacent components 202. In some examples, the inserting 505 comprises inserting the injection shaft 104 into the bore 204 from the exterior region 222 of the adjacent components 202 and/or of the assembly 200.

The inserting 505 is performed with any suitable sequence or timing within methods 500. As examples, the inserting 505 is be performed prior to, or at least substantially simultaneously with, forming 510 the fluid seal 118 and/or forming 515 the flow barrier 117. Additionally or alternatively, the inserting 505 is be performed prior to flowing 520 the liquid shim material 108 into the gap 220, prior to ceasing 525 the flowing, and/or prior to removing 530 the injection shaft 104 from the bore 204.

With continued reference to FIG. 5, methods 500 include forming 510 a fluid seal 118 between the liquid shim injection device 100 and the interior component 205 of the adjacent components 202. The forming 510 the fluid seal 118 additionally or alternatively may be referred to herein as fluidly isolating the interior region 224 of the assembly 200 from the gap 220. The forming 510 the fluid seal 118 comprises forming the fluid seal 118 with the actuated fluid seal 116 of the liquid shim injection device 100. In some examples, the forming 510 the fluid seal 118 comprises transitioning the actuated fluid seal 116 from the translation conformation 124, in which the actuated fluid seal 116 does not form the fluid seal 118 with the interior component 205, to a sealing conformation 122, in which the actuated fluid seal 116 forms the fluid seal 118 with the interior component 205. Additionally or alternatively, the forming 510 the fluid seal 118 comprises increasing an outermost lateral seal-dimension 123 of the actuated fluid seal 116. As a more specific example, the forming 510 the fluid seal 118 comprises compressing the actuated fluid seal 116 along the length of the liquid shim injection device 100 to expand and/or increase the outermost lateral seal-dimension 123 of the actuated fluid seal 116. As discussed herein, the compressing the actuated fluid seal 116 optionally comprises compressing the actuated fluid seal 116 against a distal end of the injection shaft 104.

In some examples, the forming 510 the fluid seal 118 comprises actuating the actuated fluid seal 116 with a fluid seal actuator assembly 130, such as discussed herein. As examples, the forming 510 the fluid seal 118 comprises actuating the actuated fluid seal 116 from the exterior region 222 of the adjacent components 202, opposite the actuated fluid seal 116, and/or from a proximal end region 154 of the liquid shim injection device 100 that may be opposite the actuated fluid seal 116 and/or positioned within the exterior region 222. As more specific examples, the forming 510 the fluid seal 118 comprises transmitting actuation stimulus from the proximal end region 154 of the liquid shim injection device 100 and/or from the exterior region 222 to the actuated fluid seal 116 with an actuator connecting member 134 of the fluid seal actuator assembly 130, such as discussed herein. As yet a more specific example, when the actuator connecting member 134 comprises an actuation rod 136 that is associated with the actuated fluid seal 116 and/or includes a fluid seal seat 178 that supports a distal end of the actuated fluid seal 116, the forming 510 the fluid seal 118 comprises translating a proximal end region of the actuation rod 136 away from the actuated fluid seal 116 and/or away from the interior component 205.

In some examples, the forming 510 the fluid seal 118 comprises securing and/or maintaining the actuated fluid seal 116 in the sealing conformation 122. As a more specific example, when the fluid seal actuator assembly 130 comprises an actuator retention mechanism 180, the forming the fluid seal 118 at 510 comprises engaging the actuator retention mechanism 180 to secure or maintain the actuated fluid seal 116 in the sealing conformation 122, such as discussed herein.

The forming 510 the fluid seal 118 comprises forming the fluid seal 118 between the liquid shim injection device 100 and any suitable portion of the interior component 205, with examples including an interior-facing surface 234 of the interior component 205, an interior component gap-facing surface 236, within the bore 204 in the interior component 205, and/or combinations thereof.

The forming 510 the fluid seal 118 is performed with any suitable sequence or timing within methods 500, such as subsequent to, or substantially simultaneously with, the inserting 505, prior to, substantially simultaneously with, and/or subsequent to forming 515 the fluid barrier 114, and/or prior to flowing 520 the liquid shim material 108. As a more specific example, when the inserting 505 comprises positioning the actuated fluid seal 116 proximate and/or within the bore 204 in the interior component 205, and methods 500 subsequently comprise transitioning actuated fluid seal 116 to the sealing conformation 122 to form fluid seal 118 with the interior component 205 to perform the forming 510 the fluid seal 118. Alternatively, the inserting 505 comprises positioning at least a portion of the actuated fluid seal 116 in the interior region 224, subsequently increasing the outermost dimension of the actuated fluid seal 116 while the actuated fluid seal 116 is within the interior region 224, and subsequently translating the actuated fluid seal 116 towards the interior component 205 to contact and form the fluid seal 118 with an interior-facing surface 234 of the interior component 205. In other words, in some examples, the inserting 505 is performed as a portion of the forming the fluid seal 118 at 510.

With continued reference to the examples of FIG. 5, methods 500 optionally include forming 515 a flow barrier 117 between the liquid shim injection device 100 and the exterior component 206 of the adjacent components 202. The forming 515 the flow barrier 117 additionally or alternatively may be referred to as fluidly isolating the gap 220 between the adjacent components 202 from the exterior region 222. In some examples, the forming 515 comprises forming a flow barrier 117 between a fluid barrier 114 of the liquid shim injection device 100 and the exterior component 206, such as discussed herein. As a more specific example, when the liquid shim injection device 100 comprises a circumferential ledge 150, the fluid barrier 114 is disposed along the underside of the circumferential ledge 150 and the fluid barrier 114 and the circumferential ledge 150 form a stop collar, the forming 515 the flow barrier 117 optionally is performed as a portion of the inserting 505 and comprises positioning the injection shaft 104 and/or actuated fluid seal 116 at a desired position within the bore 204.

The forming 515 the flow barrier 117 comprises forming the flow barrier 117 between the liquid shim injection device 100 and any suitable portion of the exterior component 206, such as an exterior-facing surface 230 of the exterior component 206, an exterior component gap-facing surface 232, the bore 204 within the exterior component 206, and/or combinations thereof. In some examples, the actuated fluid seal 116 is a first actuated fluid seal 116 and the fluid barrier 114 is, or includes, a second actuated fluid seal 116. In some such examples, the forming 515 the flow barrier 117 comprises actuating the second actuated fluid seal 116, such as discussed herein for the forming 510 the fluid seal 118, to form a second fluid seal 118 between the liquid shim injection device 100 and the exterior component 206.

When included, the forming 515 the flow barrier 117 is performed with any suitable sequence or timing within methods 500, such as subsequent to, or substantially simultaneously with, the inserting 505, prior to, substantially simultaneously with, or subsequent to the forming 510 the fluid seal 118, and/or prior to flowing 520 the liquid shim material 108.

As shown in FIG. 5, methods 500 comprise flowing 520 the liquid shim material 108 from the liquid shim injection device 100 into the gap 220 between the adjacent components 202. The flowing 520 additionally or alternatively may be referred to as extruding, depositing, and/or injecting an extruded liquid shim material 109 into the gap 220. In some examples, the flowing 520 comprises flowing liquid shim material 108 from within a liquid shim conduit 106 of the liquid shim injection device 100 through the fluid-permeable region 110 that is formed along the injection shaft 104. Stated differently, the flowing 520 comprises extruding the liquid shim material 108 from the fluid-permeable region 110 of the injection shaft 104. In some such examples, the flowing 520 comprises extruding the liquid shim material 108 in an outward direction from the injection shaft 104, and optionally evenly about, or with respect to, the perimeter and/or circumference of the injection shaft 104. As discussed herein, the liquid shim injection device 100 optionally comprises a liquid shim delivery system 152 that is configured to selectively and operably provide the liquid shim material 108 to the liquid shim conduit 106. In such examples, the flowing 520 comprises flowing, by the liquid shim delivery system 152, the liquid shim material 108 to the liquid shim conduit 106 to flow the liquid shim material 108 from the liquid shim conduit 106 to within the gap 220.

As discussed herein, in some examples, the liquid shim injection device 100 comprises an actuated fluid-permeable region 144 that is configured to be selectively transitioned among a flowing configuration 146 and a closed configuration 148. In such examples, the flowing 520 optionally includes transitioning the actuated fluid-permeable region 144 from the closed configuration 148 to the flowing configuration 146 and/or maintaining the actuated fluid-permeable region 144 in the flowing configuration 146 during the flowing 520.

In some examples, the flowing 520 comprises filling an annular region 226 of the gap 220 that surrounds the bore 204 with liquid shim material 108. In some examples, the annular region 226 comprises an annular diameter and the bore 204 comprises a bore diameter, and the annular diameter is at least a threshold fraction of the bore diameter. Examples of the threshold fraction of the annular diameter to the bore diameter include at least 101%, at least 105%, at least 110%, at least 120%, at least 150%, at least 200%, at most 150%, at most 200%, at most 300%, and/or at most 400%. In some examples, the flowing 520 comprises flowing a predetermined volume of the liquid shim material 108 from the liquid shim conduit 106, in which the predetermined volume is selected on any suitable basis, such as corresponding to a volume of the annular region 226 and/or the annular diameter of the annular region 226, such as discussed herein. In some examples, the flowing 520 comprises flowing, by the liquid shim delivery system 152, a predetermined volume of liquid shim material 108 to within the liquid shim conduit 106, such that a predetermined volume of extruded liquid shim material 109 is deposited within the gap 220.

In some examples, the flowing 520 comprises confining the extruded liquid shim material 109 to within a defined region exterior to the injection shaft 104, in which the confined region may include the gap 220, the annular region 226, and/or at least portion of the bore 204. As an example, the confining the liquid shim material 108 within the defined region includes utilizing the fluid seal 118 and optionally the flow barrier 117 to confine the liquid shim material 108 to within the defined region. More specifically, in some examples, the flowing 520 comprises preventing, by the actuated fluid seal 116, the extruded liquid shim material 109 from flowing to the interior region 224, and optionally a portion of the bore 204 that extends through the interior component 205. When methods 500 include the forming 515 the flow barrier 117, the flowing 520 may include preventing, by the fluid barrier 114, the extruded liquid shim material 109 from flowing to the exterior region 222, and optionally a portion of the bore 204 that extends through the exterior component 206.

The flowing 520 the liquid shim material 108 is performed with any suitable sequence or timing within methods 500. As examples, the flowing 520 is performed subsequent to the inserting 505, subsequent to the forming 510 the fluid seal 118, subsequent to forming 520 the flow barrier 117, prior to ceasing 525 the flowing, prior to removing 530 the injection shaft 104 from the bore 204, and/or prior to hardening 535 the liquid shim material 108.

With continued reference to FIG. 5, methods 500 optionally include ceasing 525 flowing the liquid shim material 108 into the gap 220. As examples, the ceasing 525 comprises ceasing flowing the liquid shim material 108 when the predetermined volume of liquid shim material 108 is deposited in the gap 220, when the annular region 226 surrounding the bore 204 is filled with extruded liquid shim material 109, and/or when the annular diameter is the threshold fraction of the bore diameter. In some examples, the ceasing 525 comprises ceasing, by the liquid shim delivery system 152, the providing or flowing the liquid shim material 108 to the liquid shim conduit 106. Additionally or alternatively, when the liquid shim injection device 100 comprises the actuated fluid-permeable region 144, the ceasing 525 may comprise transitioning the actuated fluid-permeable region 144 from the flowing configuration 146 to the closed configuration 148. When included, the ceasing 525 is performed with any suitable sequence or timing within methods 500, such as subsequent to the flowing 520, prior to the removing 530, and/or prior to the hardening 535.

Methods 500 further may include removing 530 the injection shaft 104 from the bore 204. In some examples, the removing 530 comprises removing the injection shaft 104 from the bore 204 from the exterior region 222. In some examples, the removing 530 includes transitioning the actuated fluid seal 116 from the sealing conformation 122 to the translation conformation 124. When the flowing 520 includes depositing extruded liquid shim material 109 in the bore 204, the removing 530 optionally includes removing at least some of the extruded liquid shim material 109 in the bore 204 from within the bore 204. More specifically, in some examples, the removing 530 includes conforming the actuated fluid seal 116 such that the outermost lateral seal-dimension 123 of the actuated fluid seal 116 closely corresponds to the diameter, or inner circumference, of the bore 204 and translating the actuated fluid seal 116 from within the bore 204, such that the actuated fluid seal 116 urges, pushes, or flows the extruded liquid shim material 109 that is within the bore 204 to the exterior region 222 and/or to within the gap 220.

As discussed herein, in some examples, the liquid shim injection device 100 comprises a curing shaft that may be operably coupled to, or define, a distal end region 156 of liquid shim injection device 100. In such examples, the removing 530 comprises positioning the curing shaft within the bore 204, such that the curing shaft prevents extruded liquid shim material 109 within the gap 220 from flowing within the bore 204, to the exterior region 222, and/or to the interior region 224. In some such examples, the removing 530 further includes decoupling the liquid shim injection device 100 from the curing shaft once the curing shaft is positioned operably within the bore 204.

When included, the removing 530 is performed with any suitable sequence or timing within methods 500, such as subsequent to the flowing 520, subsequent to the ceasing 525, prior to the hardening 535, subsequent to the hardening, and/or prior to the finishing 540.

As shown in FIG. 5, in some examples, methods 500 comprise hardening 535 the extruded liquid shim material 109 within the gap 220. Examples of the hardening 535 the extruded liquid shim material 109 within the gap 220 include curing the extruded liquid shim material 109, setting the extruded liquid shim material 109, and/or solidifying the extruded liquid shim material 109. Stated differently, the hardening 535 the extruded liquid shim material 109 additionally or alternatively may be referred to as converting the extruded liquid shim material 109 within the gap 220 into a structural shim material. In some examples, the hardening 535 comprises setting and/or solidifying the extruded liquid shim material 109 by permitting the extruded liquid shim material 109 to set and/or solidify for a setting time. Examples of the setting time include at least 5 minutes, at least 10 minutes, at least 20 minutes, at least 30 minutes, at most 30 minutes, and/or at most 60 minutes. In some examples, the hardening 535 includes curing the extruded liquid shim material 109 and/or the set or solidified liquid shim material 108, which may include permitting the extruded liquid shim material 109 and/or the set or solidified liquid shim material 108 to cure for a curing time. In some examples, the curing is performed substantially simultaneously with the setting. Examples of the curing time include at least 1 hour, at least 2 hours, at least 4 hours, at least 6 hours, at least 8 hours, at most 4 hours, at most 6 hours, at most 8 hours, at most 12 hours, at most 24 hours, and/or at most 48 hours.

In some examples, the hardening 535 is performed once the injection shaft 104 is removed from the bore 204 at 530. Additionally or alternatively, at least a portion of the hardening 535 is performed while the injection shaft 104 is positioned operably within the bore 204. In specific examples, methods 500 include maintaining the injection shaft 104 positioned operably within the bore 204, maintaining the fluid seal 118 in the sealing conformation 122, and/or maintaining the flow barrier 117 during the setting the extruded liquid shim material 109 and/or during the setting and/or for the duration of the setting time. In some such examples, methods 500 comprise performing the removing 530 subsequent to the setting. Alternatively, in some examples, the hardening 535 comprises performing the setting and/or the curing while the curing shaft is positioned operably within the bore 204, without any additional structure positioned in the bore 204. As yet another example, methods 500 may include inserting a fastener into the bore 204 subsequent to the removing 530 and performing the hardening with the fastener inserted within the bore 204.

When included, the hardening 535 is performed with any suitable sequence or timing within methods 500. As examples, the hardening 535 is performed subsequent to the flowing 520, subsequent to the ceasing 525, and/or prior to, or substantially simultaneously with, finishing 540 the bore 204. As more examples, the hardening 535 is be performed prior to the removing 530, substantially simultaneously with the removing 530, and/or subsequent to the removing 530.

With continued reference to FIG. 5, in some examples, methods 500 comprise finishing 540 the bore 204. As mentioned, in some examples, the flowing 520 comprises depositing the extruded liquid shim material 109 within the bore 204. Additionally or alternatively, a portion of the extruded liquid shim material 109 within the gap 220 flows into the bore 204, such as during the hardening 535. With this in mind, the finishing 540 optionally comprises removing set or solidified liquid shim material 108 from within the bore 204 and/or removing cured liquid shim material 108 from within the bore 204. Stated differently, at least a portion of the finishing 540 the bore 204 may be performed subsequent to the setting and/or subsequent to the curing. In particular, when the finishing 540 comprises removing the set, solidified, or cured liquid shim material 108 from within the bore 204, the finishing 540 may include reaming or drilling the bore 204 to remove the set, solidified, or cured liquid shim material 108 from within the bore 204 and/or may be performed to widen the bore 204 to its original diameter or dimension and/or to widen the bore 204 to a desired diameter or dimension.

When included, the finishing 540 the bore 204 is performed with any suitable sequence or timing within methods 500, with examples including substantially simultaneously with, or subsequent to, the hardening 535, subsequent to the ceasing 525, and/or subsequent to the flowing 520.

As shown in FIG. 5, methods 500 optionally comprise repeating 545. The repeating 545 may be performed subsequent to any other step of methods 500 and/or may include repeating any suitable sequence or combination of steps of methods 500. In some examples, the assembly 200 comprises a plurality of bores 204 that extend through the adjacent components 202, and methods 500 comprise repeating 545 any suitable sequence or combination of steps of methods 500 to inject liquid shim material 108 into the gap 220 surrounding at least a subset of, or each of, the plurality of bores 204.

With reference to FIG. 4 for a more specific example, the plurality of bores 204 include the plurality of bores 204 that extend through the upper wing panel 304 and the wing spars 308, 310, or any of the other adjacent components 202 of wing box 302 discussed herein. Additionally or alternatively, in some examples, the assembly 200 comprises a plurality of adjacent components 202 and a plurality of corresponding gaps 220 that extend between the plurality of adjacent components 202, and the repeating 545 comprises repeating any suitable sequence or combination of steps of methods 500 to inject liquid shim material 108 into at least a subset of, or each of, the plurality of gaps 220. With reference to FIG. 4 for a more specific example, the plurality of adjacent components 202 may include upper wing panel 304 and one of the wing spars 308, 310, upper wing panel 304 and rib 312, lower wing panel 306 and one of the wing spars 308, 310, and/or lower wing panel 306 and rib 312.

Illustrative, non-exclusive examples of inventive subject matter according to the present disclosure are described in the following enumerated paragraphs:

A1. A liquid shim injection device (100), comprising:
a body (102), comprising:
an injection shaft (104);
a liquid shim conduit (106) defined within the body (102) and configured to channel a liquid shim material (108) within the injection shaft (104); and
a fluid-permeable region (110) formed along the injection shaft (104) and configured to provide fluid communication between the liquid shim conduit (106) and an exterior (112) to the injection shaft (104);
an actuated fluid seal (116) operably coupled to the injection shaft (104) and configured to be selectively conformed among a plurality of conformations that includes a sealing conformation (122) and a translation conformation (124), the actuated fluid seal (116) has an outermost lateral seal-dimension (123) that is greater in the sealing conformation (122) than in the translation conformation (124); and
a fluid seal actuator assembly (130) associated with the actuated fluid seal (116) and configured to selectively and operably transition the actuated fluid seal (116) among the plurality of conformations.

A2. The liquid shim injection device (100) of paragraph A1, further comprising a fluid barrier (114) operably coupled to the body (102) and configured to form a flow barrier (117).

A2.1. The liquid shim injection device (100) of paragraph A2, wherein the fluid-permeable region (110) is positioned between the fluid barrier (114) and the actuated fluid seal (116).

A2.2. The liquid shim injection device (100) of any of paragraphs A2-A2.1, wherein the actuated fluid seal (116) is a first actuated fluid seal, and wherein the fluid barrier (114) is a second actuated fluid seal.

A2.3. The liquid shim injection device (100) of any of paragraphs A2-A2.2, wherein the fluid barrier (114) comprises a gasket.

A3. The liquid shim injection device (100) of any of paragraphs A1-A2.3, wherein the liquid shim injection device (100) defines a proximal portion (140) and a distal portion (142) that are separated from one another by the fluid-permeable region (110), and wherein the actuated fluid seal (116) forms a portion of the distal portion (142).

A3.1. The liquid shim injection device (100) of paragraph A3, when depending from paragraph A2, wherein the fluid barrier (114) forms a portion of the proximal portion (140).

A3.2.1 The liquid shim injection device (100) of paragraph A3.1, wherein the body (102) comprises a circumferential ledge (150) positioned proximate the injection shaft (104) and within the proximal portion (140), wherein the fluid barrier (114) is positioned along an underside of the circumferential ledge (150).

A4. The liquid shim injection device (100) of any of paragraphs A2-A3.2.1, wherein the actuated fluid seal (116) and the fluid barrier (114) are configured to confine an extruded liquid shim material (109) that is extruded from the fluid-permeable region (110) to within a defined region exterior to the injection shaft (104).

A5. The liquid shim injection device (100) of any of paragraphs A1-A4, wherein the injection shaft (104) comprises an outermost lateral shaft-dimension (113), wherein the outermost lateral seal-dimension (123) is greater than the outermost lateral shaft-dimension (113) when the actuated fluid seal (116) is in the sealing conformation (122).

A5.1 The liquid shim injection device (100) of paragraph A5, wherein the outermost lateral seal-dimension (123) is equal to or less than the outermost lateral shaft-dimension (113) when the actuated fluid seal (116) is in the translation conformation (124) .

A6. The liquid shim injection device (100) of any of paragraphs A1-A5.1, wherein the actuated fluid seal (116) comprises a resilient body (160), and wherein fluid seal actuator assembly (130) is configured to selectively deform the resilient body (160) to selectively and operably transition the actuated fluid seal (116) among the plurality of conformations.

A6.1 The liquid shim injection device (100) of paragraphs A6, when depending from paragraph A5, wherein the resilient body (160) defines the outermost lateral seal-dimension (123), and wherein the resilient body (160) is configured to be selectively deformed to change the outermost lateral seal-dimension (123) of the actuated fluid seal (116).

A7. The liquid shim injection device (100) of any of paragraphs A1-A6.1, wherein the actuated fluid seal (116) is one or more of mechanically actuated, fluidly actuated, pneumatically actuated, hydraulically actuated, and electrically actuated.

A8. The liquid shim injection device (100) of any of paragraphs A1-A7, wherein at least one of a portion of the fluid seal actuator assembly (130) or the actuated fluid seal (116) form a distal end region (156) of the liquid shim injection device (100).

A9. The liquid shim injection device (100) of any of paragraphs A1-A8, wherein the fluid seal actuator assembly (130) comprises one or more of mechanical actuator assembly, a fluid actuator assembly, a pneumatic actuator assembly, a hydraulic actuator assembly, or an electrical actuator assembly.

A10. The liquid shim injection device (100) of any of paragraphs A1-A9, wherein the fluid seal actuator assembly (130) is configured to permit actuation of the actuated fluid seal (116) from a proximal end region (154) of the liquid shim injection device (100).

A10.1. The liquid shim injection device (100) of paragraph A10, wherein the fluid seal actuator assembly (130) comprises an actuator connecting member (134) that extends along the injection shaft (104) from the proximal end region (154) to the actuated fluid seal (116) and is configured to transmit actuation stimulus from the proximal end region (154) to the actuated fluid seal (116).

A10.1.1. The liquid shim injection device (100) of paragraph A10.1, wherein the actuator connecting member (134) comprises at least one of a fluid conduit, an electrical power conduit, or a mechanical connection.

A10.1.2. The liquid shim injection device (100) of any of paragraphs A10.1-A10.1.1, wherein the actuator connecting member (134) comprises an actuation rod (136) operably coupled to the actuated fluid seal (116), extending through the injection shaft (104), and configured to be selectively translated to transition the actuated fluid seal (116) among the plurality of conformations.

A10.1.2.1.The liquid shim injection device (100) of paragraph A10.1.2,

wherein when the actuation rod (136) is selectively translated away from the actuated fluid seal (116), the actuated fluid seal (116) transitions toward the sealing conformation (122); and

wherein when the actuation rod (136) is selectively translated toward the actuated fluid seal (116), the actuated fluid seal (116) transitions toward the translation conformation (124).

A11. The liquid shim injection device (100) of any of paragraphs A1-A10.1.2.1., wherein the fluid-permeable region (110) forms a cylindrical annulus about the injection shaft (104).

A12. The liquid shim injection device (100) of any of paragraphs A1-A11, wherein the fluid-permeable region (110) is configured to extrude the liquid shim material (108) in an outward direction from the injection shaft (104) towards the exterior (112) to the injection shaft (104).

A13. The liquid shim injection device (100) of any of paragraphs A1-A12, wherein the fluid-permeable region (110) is configured to extrude the liquid shim material (108) evenly about a perimeter the injection shaft (104).

A14. The liquid shim injection device (100) of any of paragraphs A1-A13, wherein the fluid-permeable region (110) is an actuated fluid-permeable region (144) comprising a flowing configuration (146) and a closed configuration (148), wherein the actuated fluid-permeable region (144) is configured to provide fluid communication between the liquid shim conduit (106) and the exterior (112) to the injection shaft (104) in the flowing configuration (146), and wherein the actuated fluid-permeable region (144) is configured to restrict fluid communication between the liquid shim conduit (106) and the exterior (112) to the injection shaft (104) in the closed configuration (148).

A15. The liquid shim injection device (100) of any of paragraphs A1-A14, further comprising a liquid shim delivery system (152) that is in fluid communication with the liquid shim conduit (106) and configured to selectively and operably provide the liquid shim material (108) to the liquid shim conduit (106).

A15.1. The liquid shim injection device (100) of paragraph A15, wherein the liquid shim delivery system (152) is configured to selectively flow the liquid shim material (108) to the liquid shim conduit (106) to selectively extrude the liquid shim material (108) from the fluid-permeable region (110).

A15.2. The liquid shim injection device (100) of any of paragraphs A15-A15.1, wherein the liquid shim delivery system (152) is configured to selectively flow a predetermined volume of the liquid shim material (108) through the liquid shim conduit (106) to extrude the predetermined volume of the liquid shim material (108) through the fluid-permeable region (110).

A15.3. The liquid shim injection device (100) of any of paragraphs A15-A15.2, wherein the liquid shim delivery system (152) comprises at least one of a pump (162) configured to pump the liquid shim material (108), a liquid shim reservoir (164) configured to contain a volume of the liquid shim material (108), and a liquid shim line (166) that is in fluid communication with an external source (168) of liquid shim material (108) .

A16. The liquid shim injection device (100) of any of paragraphs A1-A15.3, wherein the liquid shim injection device (100) is configured to be at least one of mounted to, mounted with, or mounted as an end effector of a robotic arm (170) or robotic device.

B1. A liquid shim injection device (100) configured to inject a liquid shim material (108) into a gap (220) between adjacent components (202) of an assembly (200), the liquid shim injection device (100) comprising:

a body (102), comprising:
an injection shaft (104) configured to be inserted within a bore (204) that extends through the adjacent components (202) of the assembly (200);
a liquid shim conduit (106) defined within the body (102) and configured to channel the liquid shim material (108) within the injection shaft (104); and
a fluid-permeable region (110) formed along the injection shaft (104) and configured to provide fluid communication between the liquid shim conduit (106) and an exterior (112) of the injection shaft (104), wherein the fluid-permeable region (110) is positioned along the injection shaft (104) such that at least a portion of the fluid-permeable region (110) is positioned within the gap (220) when the injection shaft (104) is positioned operably within the bore (204);
an actuated fluid seal (116) operably coupled to the injection shaft (104) and configured to selectively form a fluid seal (118) with an interior component (205) of the adjacent components (202), wherein the actuated fluid seal (116) has a plurality of conformations that includes a sealing conformation (122) and a translation conformation (124), wherein in the sealing conformation (122) of the actuated fluid seal (116) is configured to form the fluid seal (118) with the interior component (205), and wherein in the translation conformation (124) of the actuated fluid seal (116) is configured to be selectively inserted through the bore (204); and
a fluid seal actuator assembly (130) associated with the actuated fluid seal (116) and configured to selectively and operably transition the actuated fluid seal (116) among the plurality of conformations.

B2. The liquid shim injection device (100) of paragraph B1, further comprising a fluid barrier (114) operably coupled to the body (102) and configured to form a flow barrier (117) with an exterior component (206) of the adjacent components (202).

B3. The liquid shim injection device (100) of any of paragraphs B1-B2, further comprising the subject matter of any of paragraphs A1-A16.

C1. A method (500) of injecting a liquid shim material (108) into a gap (220) between adjacent components (202) of an assembly (200), the method (500) comprising:
inserting (505) an injection shaft (104) of a liquid shim injection device (100) into a bore (204) that extends through the adjacent components (202);
forming (510) a fluid seal (118) between the liquid shim injection device (100) and an interior component (205) of the adjacent components (202); and
flowing (520) the liquid shim material (108) from the liquid shim injection device (100) into the gap (220).

C2. The method (500) of paragraph C1, wherein the inserting (505) comprises positioning at least a portion of a fluid-permeable region (110) of the injection shaft (104) within the gap (220).

C3. The method (500) of any of paragraphs C1-C2, wherein the inserting (505) comprises inserting the injection shaft (104) into the bore (204) from an exterior region (222) of the adjacent components (202).

C4. The method (500) of any of paragraphs C1-C3, further comprising forming (515) a flow barrier (117) between the liquid shim injection device (100) and an exterior component (206) of the adjacent components (202).

C5. The method (500) of any of paragraphs C1-C4, wherein the forming (510) the fluid seal (118) comprises forming the fluid seal (118) with an actuated fluid seal (116) of the liquid shim injection device (100).

C5.1. The method (500) of paragraph C5, wherein the forming (510) the fluid seal (118) comprises transitioning the actuated fluid seal (116) from a translation conformation (124), in which the actuated fluid seal (116) does not form the fluid seal (118) with the interior component (205), to a sealing conformation (122), in which the actuated fluid seal (116) forms the fluid seal (118) with the interior component (205).

C6. The method (500) of any of paragraphs C1-C5.1, wherein the forming (510) the fluid seal (118) comprises increasing an outermost lateral seal-dimension (123) of the actuated fluid seal (116).

C7. The method (500) of any of paragraphs C1-C6, wherein the forming (510) the fluid seal (118) comprises actuating the actuated fluid seal (116) from the exterior region (222) of the adjacent components (202), opposite the actuated fluid seal (116).

C8. The method (500) of any of paragraphs C1-C7, wherein the flowing (520) the liquid shim material (108) comprises filling an annular region (226) of the gap (220) that surrounds the bore (204) with the liquid shim material (108).

C8.1. The method (500) of paragraph C8, wherein the annular region (226) comprises an annular diameter and the bore (204) comprises a bore diameter, wherein the annular diameter is at least a threshold fraction of the bore diameter of the bore (204), wherein the threshold fraction is at least one of at least 101%, at least 105%, at least 110%, at least 120%, at least 150%, at least 200%, at most 150%, at most 200%, at most 300%, and at most 400%.

C9. The method (500) of any of paragraphs C1-C8.1, wherein the flowing (520) the liquid shim material (108) comprises extruding the liquid shim material (108) from a/the fluid-permeable region (110) of the injection shaft (104).

C10. The method (500) of any of paragraphs C1-C9, further comprising ceasing (525) the flowing the liquid shim material (108).

C11. The method (500) of any of paragraphs C1-C10, further comprising removing (530) the injection shaft (104) from the bore (204).

C11.1. The method (500) of paragraph C11, wherein the removing (530) the injection shaft (104) from the bore (204) comprises positioning a curing shaft of the liquid shim injection device (100) within the bore (204).

C12. The method (500) of any of paragraphs C1-C11.1, further comprising hardening (535) the liquid shim material (108) within the gap (220).

C13. The method (500) of any of paragraphs C1-C12, wherein the assembly (200) comprises a plurality of bores (204) that extend through the adjacent components (202), wherein the method (500) further comprises repeating (545) the method (500) of any of paragraphs C1-C12 to inject the liquid shim material (108) into the gap (220) surrounding at least a subset of, or each of, the plurality of bores (204).

C14. The method (500) of any of paragraphs C1-C13, wherein the assembly (200) comprises a plurality of adjacent components (202) and a corresponding a plurality of gaps (220) that extend between the plurality of adjacent components (202), wherein the method (500) comprises repeating (545) the method (500) of any of paragraphs C1-C13 to inject the liquid shim material (108) into at least a subset of, or each of, the plurality of gaps (220).

C15. The method (500) of any of paragraphs C1-C14, wherein the liquid shim injection device (100) comprises the liquid shim injection device (100) of any of paragraphs A1-B3.

D1. The use of the liquid shim injection device (100) of any of paragraphs A1-B3 to inject liquid shim material into a gap separating adjacent components of an assembly.

D2. The use of the liquid shim injection device (100) of any of paragraphs A1-B3 to perform the methods of any of paragraphs C1-C14.

Liquid shim injection devices and methods for injecting liquid shim material into a gap between adjacent components of an assembly are disclosed herein. The liquid shim injection devices comprise a body, which comprises an injection shaft, a liquid shim conduit defined within the body and configured to channel liquid shim material within the injection shaft, and a fluid-permeable region formed along the injection shaft and configured to provide fluid communication between the liquid shim conduit and an exterior to the injection shaft. The liquid shim injection devices also comprise an actuated fluid seal operably coupled to the injection shaft and configured to be selectively conformed among a plurality of conformations that include a translation conformation and a sealing conformation, in which the actuated fluid seal has an outermost lateral seal-dimension that is greater in the sealing conformation than in the translation conformation. The liquid shim injection devices further comprise a fluid seal actuator assembly associated with the actuated fluid seal and configured to selectively and operably transition the actuated fluid seal among the plurality of conformations.

The methods comprise inserting an injection shaft of the liquid shim injection device into a bore that extends through the adjacent components of the assembly, forming a fluid seal between the liquid shim injection device and an interior component of the assembly, and flowing the liquid shim material from the liquid shim injection device into the gap.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, an object that is at least substantially formed from a material includes an object for which at least 75% of the object is formed from the material and also includes an object that is completely formed from the material. As another example, a first direction that is at least substantially parallel to a second direction includes a first direction that forms an angle with respect to the second direction that is at most 22.5 degrees and also includes a first direction that is exactly parallel to the second direction. As another example, a first length that is substantially equal to a second length includes a first length that is at least 75% of the second length, a first length that is equal to the second length, and a first length that exceeds the second length such that the second length is at least 75% of the first length.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

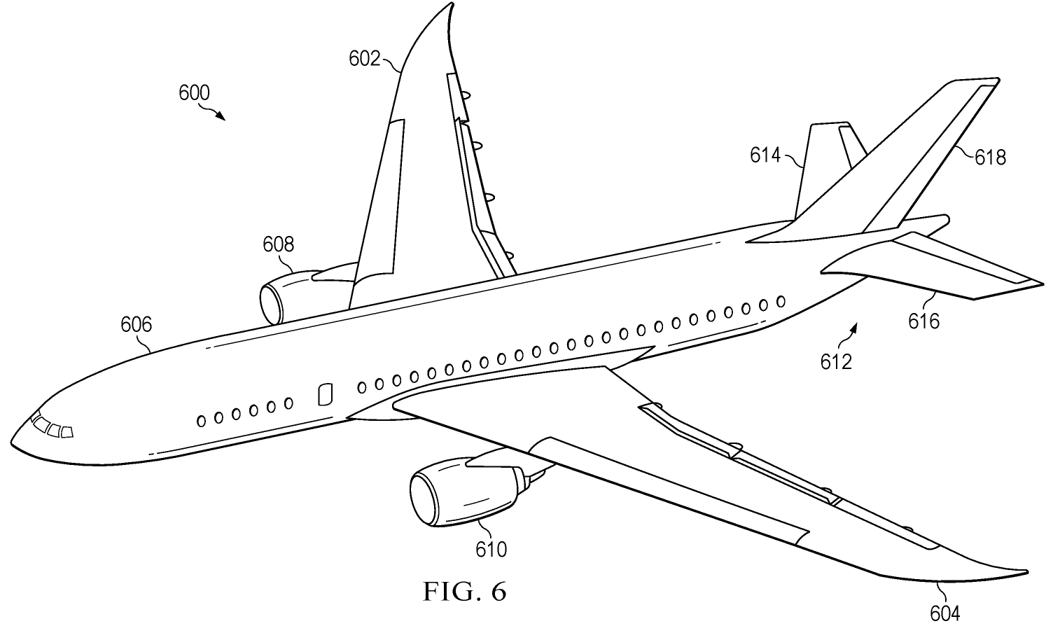

Turning now to FIG. 6, an illustration of an aircraft is depicted in accordance with an illustrative embodiment. Aircraft 600 has wing 602 and wing 604 attached to body 606. Aircraft 600 includes engine 608 attached to wing 602 and engine 610 attached to wing 604.

Body 606 has tail section 612. Horizontal stabilizer 614, horizontal stabilizer 616, and vertical stabilizer 618 are attached to tail section 612 of body 606.

Aircraft 600 is an example of an aircraft having joints that can be manufactured using structural gap filler and methods of use. For example, a fuel tank in wing 602 or wing 604 can be manufactured using the illustrative examples of structural gap filler and methods of use. As another example, joints in portions of body 606, wing 602, or wing 604 can be manufactured using the illustrative examples of structural gap filler and methods of use.

In some illustrative examples, liquid shim injection devices 100 of FIGS. 1-3 can be used to manufacture portions of aircraft 600. In some illustrative examples, assemblies 200 of FIGS. 1, 3, and 4 can be portions of aircraft 600. In some illustrative examples, method 500 can be a method of injecting liquid shim in aircraft 600.

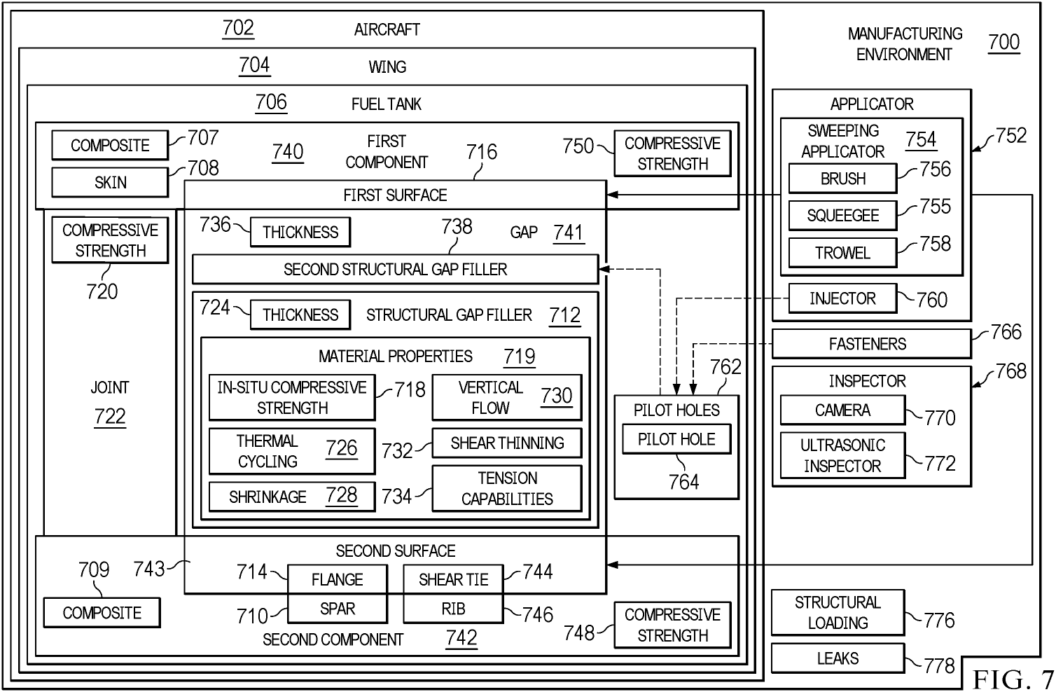

Turning now to FIG. 7, an illustration of a block diagram of a manufacturing environment is depicted in which an illustrative embodiment may be implemented. Manufacturing environment 700 is a manufacturing environment in which a component of aircraft 600 can be manufactured. Portions of aircraft 702 can be manufactured in manufacturing environment 700. In some illustrative examples, assemblies 200 of FIGS. 1, 3, and 4 can be portions of aircraft 702. In some illustrative examples, liquid shim injection devices 100 of FIGS. 1-3 can be an example of injector 760.

As depicted, aircraft 702 comprises first component 740, second component 742, and structural gap filler 712 between first surface 716 of first component 740 and second surface 743 of second component 742. Structural gap filler 712 has in-situ compressive strength 718 equivalent to or greater than compressive strength 720 of joint 722 between first component 740 and second component 742. Structural gap filler 712 reduces or eliminates gaps between first surface 716 of first component 740 and second surface 743 of second component 742. Use of structural gap filler 712 eliminates manufacturing steps and reduces manufacturing time and cost.

First component 740 and second component 742 can be any desirable components of aircraft 702 to form a joint, joint 722. In some illustrative examples, thickness 724 of structural gap filler 712 is up to 0.1" between first surface 716 of first component 740 and second surface 743 of second component 742.

Structural gap filler 712 is applied to at least one of first component 740 or second component 742 using applicator 752. In some illustrative examples, structural gap filler 712 is applied to at least one of first component 740 or second component 742 using sweeping applicator 754. In some illustrative examples, structural gap filler 712 is injected between first component 740 and second component 742 using injector 760.

In some illustrative examples, structural gap filler 712 is applied to one of first component 740 or second component 742 prior to forming joint 722. In some illustrative examples, structural gap filler 712 is spread using sweeping applicator 754 onto to one of first component 740 or second component 742. In some illustrative examples, structural gap filler 712 is spread using at least one of squeegee 755, brush 756, or trowel 758.

In some illustrative examples, second structural gap filler 738 is also present between first component 740 and second component 742. In some illustrative examples, gap 741 remaining between structural gap filler 712 and either of first component 740 or second component 742 is undesirably large. In some illustrative examples, additional structural gap filler in the form of structural gap filler 712 is injected in between first component 740 or second component 742. In some illustrative examples, additional structural gap filler in the form of second structural gap filler 738 is injected in between first component 740 or second component 742.

In some illustrative examples, structural gap filler 712 and second structural gap filler 738 have the same material properties material properties 719. In some illustrative examples, structural gap filler 712 and second structural gap filler 738 have different material properties. In some illustrative examples, structural gap filler 712 and second structural gap filler 738 have a different chemical composition. In some illustrative examples, second structural gap filler 738 is between first component 740 and second component 742 and second structural gap filler 738 was injected between first component 740 and second component 742.

In some illustrative examples, first component 740 and second component 742 are both formed of composite material. In these illustrative examples, first component 740 is formed of composite 707. In these illustrative examples, second component 742 is formed of composite 709.

In some illustrative examples, first component 740 takes the form of skin 708. In some illustrative examples, second component 742 is one of rib 746 or spar 710.

Structural gap filler 712 is configured to provide structural loading 776 of joint 722. In some illustrative examples, structural gap filler 712 is configured to substantially prevent or reduce leaks 778. By structural gap filler 712 both providing structural loading 776 and preventing leaks 778, additional material application can be reduced or eliminated. When structural gap filler 712 provides both structural loading 776 and prevents leaks 778, at least one of shimming or sealing can be reduced or eliminated.

In some illustrative examples, structural gap filler 712 is configured to fill gap 741 having thickness 736 up to 0.1". In some illustrative examples, gap 741 having thickness 736 of at least 0.005" is out of tolerance.

In some illustrative examples, after applying structural gap filler 712 to reduce or eliminate gap 741, first component 740 and second component 742 are fastened together. In some illustrative examples, fasteners 766 are installed in pilot holes 762 within first component 740 and second component 742 after applying at least one of structural gap filler 712 or second structural gap filler 738 to reduce or eliminate gap 741. In some illustrative examples, pilot holes 762 are present in first component 740 and second component 742 prior to application of structural gap filler 712. In some illustrative examples, additional manufacturing operations can be performed through pilot holes 762 prior to installing fasteners 766 into pilot holes 762. For example, at least one of structural gap filler 712 or second structural gap filler 738 can be injected into gap 741 through at least one of pilot holes 762. For example, injector 760 can be used to inject at least one of structural gap filler 712 or second structural gap filler 738 into pilot hole 764.

As another example, inspection of structural gap filler 712 within gap 741 can be performed through at least one of pilot holes 762. For example, inspector 768 can be inserted into pilot hole 764 to inspect at least one of structural gap filler 712 or gap 741.

First component 740 and second component 742 can be in any desirable portion of aircraft 702 such as a body, a tail section, or wing 704. When present in wing 704, first component 740 and second component 742 can be any desirable components of wing 704. In some illustrative examples, first component 740 and second component 742 can be parts of fuel tank 706.

As depicted, aircraft 702 has wing 704 with fuel tank 706 within wing 704. Fuel tank 706 in wing 704 comprises composite 707 skin 708, composite 709 spar 710, and structural gap filler 712 between flange 714 of spar 710 and first surface 716 of skin 708. Structural gap filler 712 has in-situ compressive strength 718 equivalent to or greater than compressive strength 720 of joint 722 between composite 709 spar 710 and composite 707 skin 708.

Compressive strength 720 of joint 722 is a preset, designed specification. Compressive strength 720 of joint 722 is set based on desired functionalities of the structure having joint 722. A joint at a different location can have a different compressive strength. For example, joint 722 in fuel tank 706 of aircraft 702 can have a greater compressive strength than a joint in a body of aircraft 702.

In some illustrative examples, structural gap filler 712 has in-situ compressive strength 718 of at least 30 ksi. In some illustrative examples, structural gap filler 712 has in-situ compressive strength 718 of at least 60 ksi. In some illustrative examples, structural gap filler 712 has compressive strength 718 equivalent to or greater than a lesser one of compressive strength 750 of the first component 740 or compressive strength 748 of second component 742.

Structural gap filler 712 is applied to one of flange 714 of spar 710 or first surface 716 of skin 708 prior to assembly. Structural gap filler 712 reduces or eliminates gaps between flange 714 of spar 710 and first surface 716 of skin 708. Use of structural gap filler 712 eliminates manufacturing steps and reduces manufacturing time and cost.

In some illustrative examples, thickness 724 of structural gap filler 712 is up to 0.1" between flange 714 of spar 710 and first surface 716 of skin 708. In some illustrative examples, structural gap filler 712 is configured to maintain desirable material characteristics, including in-situ compressive strength 718 up to thickness 724 of 0.1".

In some illustrative examples, thickness 724 of structural gap filler 712 is up to 0.06" between flange 714 of spar 710 and first surface 716 of skin 708. In some illustrative examples, structural gap filler 712 is configured to maintain desirable material characteristics, including in-situ compressive strength 718 up to thickness 724 of 0.06".

In-situ compressive strength 718 is one of material properties 719 selected for use in joint 722. Material properties 719 include at least one of thermal cycling 726, shrinkage 728, vertical flow 730, shear thinning 732, or tension capabilities 734 in addition to in-situ compressive strength 718.

Material properties 719 of structural gap filler 712 are selected based on a specific application for structural gap filler 712. Although joint 722 is depicted as being a part of fuel tank 706, joint 722 could be in any portion of aircraft 702.

Skin 708 is one example of first component 740. Spar 710 is one example of second component 742 to be joined to first component 740. In some other illustrative examples, second component 742 can take the form of rib 746 and second surface 743 to be joined to first surface 716 of first component 740 is shear tie 744 of rib 746. In some illustrative examples, first component 740 can take the form of a component other than skin 708. In some illustrative examples, second component 742 can take the form of a component other than spar 710 or rib 746.

Material properties 719 are selected based on materials of skin 708 and spar 710 such that structural gap filler 712 does not undesirably affect skin 708 and spar 710. In some illustrative examples, material properties 719 are selected to meet standards for joint 722. In some illustrative examples, material properties 719 are selected for ease of application of structural gap filler 712. In some illustrative examples, structural gap filler 712 has vertical flow 730 of less than 0.25 inch. By having vertical flow 730 of less than 0.25 inch, structural gap filler 712 will stay substantially in place after application. In some illustrative examples, structural gap filler 712 has vertical flow 730 substantially close to zero.

In some illustrative examples, structural gap filler 712 has less than 2.5% shrinkage 728 through the thickness due to curing. In some illustrative examples, structural gap filler 712 has less than 0.001" thru thickness shrinkage 728. In some illustrative examples, structural gap filler 712 is configured to withstand thermal cycling requirements 726 from -65° F. to 160° F.

Tension capabilities 734 of structural gap filler 712 are configured to meet structural requirements for joint 722. In some illustrative examples, structural gap filler 712 has tensile stress of 4 ksi.

In some illustrative examples, material properties 719 include rheology configured to inject structural gap filler 712 into gap 741 with a thickness down to 0.003". In illustrative examples in which structural gap filler 712 is not injected but second structural gap filler 738 is injected, rheology of structural gap filler 712 can be different from second structural gap filler 738.

In some illustrative examples, structural gap filler 712 has adequate leak protection properties. In these illustrative examples, structural gap filler 712 is provided to substantially prevent or reduce leaks 778 from fuel tank 706. By structural gap filler 712 preventing leaks 778, additional material application can be reduced or eliminated.

In some illustrative examples, fuel tank 706 comprises composite 709 rib 746 and a layer of structural gap filler 712 between shear tie 744 of composite 709 rib 746 and first surface 716 of skin 708.

In some illustrative examples, structural gap filler 712 was injected between flange 714 of spar 710 and first surface 716 of skin 708. In these illustrative examples, structural gap filler 712 is positioned between spar 710 and skin 708 after skin 708 and spar 710 are positioned relative to each other to form gap 741. In some of these illustrative examples, structural gap filler 712 is not swept onto skin 708 or spar 710 prior to assembly. In other illustrative examples, structural gap filler 712 is swept onto skin 708 or spar 710 using sweeping applicator 754 and then injected using injector 760 between skin 708 or spar 710.

In some illustrative examples, structural gap filler 712 is spread onto at least one of flange 714 of spar 710 or first surface 716 of skin 708. In some of these illustrative examples, structural gap filler 712 is spread using sweeping applicator 754. In some illustrative examples, structural gap filler 712 is spread using at least one of squeegee 755, brush 756, or trowel 758.

In some illustrative examples, structural gap filler 712 does not fully fill gap 741. In some illustrative examples, after positioning flange 714 of spar 710 relative to first surface 716 of skin 708, there is still part of gap 741 present between structural gap filler 712 and one of either flange 714 or first surface 716. In some illustrative examples, gap 741 remaining between structural gap filler 712 and either of flange 714 or first surface 716 is undesirably large. In some illustrative examples, additional structural gap filler in the form of second structural gap filler 738 is injected in between flange 714 and first surface 716. In some illustrative examples, second structural gap filler 738 is between flange 714 of spar 710 and first surface 716 of skin 708.

In some illustrative examples, structural gap filler 712 and second structural gap filler 738 have a different chemical composition. In some illustrative examples, the viscosity or other rheological properties of second structural gap filler 738 is different than material properties 719 of structural gap filler 712. In some illustrative examples, structural gap filler 712 and second structural gap filler 738 have different material properties due to the injecting of second structural gap filler 738.

In some illustrative examples, fuel tank 706 of aircraft 702 comprises composite 707 skin 708, composite 709 spar 710, composite 709 rib 746, and structural gap filler 712. Composite 707 skin 708 has first surface 716 facing composite 709 spar 710 and composite 709 rib 746. Structural gap filler 712 is between first surface 716 of skin 708 and flange 714 of spar 710 and between first surface 716 of skin 708 and at least one shear tie 744 of composite 709 rib 746. In some illustrative examples, structural gap filler 712 has in-situ compressive strength 718 equivalent to or greater than compressive strength 720 of joint 722 between composite 709 spar 710 and composite 707 skin 708.

In some illustrative examples, after forming joint 722, structural gap filler 712 is inspected. In some illustrative examples, it is determined if an out of tolerance gap is present between structural gap filler 712 and at least one of skin 708 or second component 742. Whether a gap is out of tolerance is based on a preset, designed specification. In some illustrative examples, determining if an out of tolerance gap is present comprises determining if a gap of at least 0.005" is present.

In response to a determination that an out of tolerance gap is present, second structural gap filler 738 is injected into the out of tolerance gap. In some illustrative examples, inspecting structural gap filler 712 is performed through a hole in skin 708. In some illustrative examples, structural gap filler 712 is inspected through one of pilot holes 762 in skin 708.

Inspection of structural gap filler 712 can be performed using inspector 768. Inspector 768 is any desirable non-destructive inspection device. In some illustrative examples, inspector 768 takes the form of camera 770. In some illustrative examples, camera 770 can inspect structural gap filler 712 from a side of joint 722. In some illustrative examples, camera 770 can be inserted through a hole, such as one of pilot holes 762 within one of first component 740 or second component 742.

In other illustrative examples, inspector 768 can take the form of ultrasonic inspector 772. In some illustrative examples, multiple inspectors can be used together to inspect structural gap filler 712.

The illustration of manufacturing environment 700 in FIG. 7 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although fuel tank 706 is discussed, first component 740 and second component 742 can be in a different portion of aircraft 702. Additionally, second structural gap filler 738 is optional. If structural gap filler 712 sufficiently fills gap 741, second structural gap filler 738 is not present.

Although not presented in material properties 719, other material properties can include desired cure time, application time, resistivity, adhesion, viscoelastic material behavior or other material properties. In some illustrative examples, a desired cure time is selected to reduce manufacturing time. In some illustrative examples, the cure time is 2 hours or less. In some illustrative examples, a desired application time is selected to reduce manufacturing time. In some illustrative examples, the application time is 30 minutes or less. In some illustrative examples, structural gap filler 712 is non-conductive. In some illustrative examples, structural gap filler 712 has little to no adhesion. Material properties 719 such as tension fatigue and torque are selected to perform desirably over the life of aircraft 702.

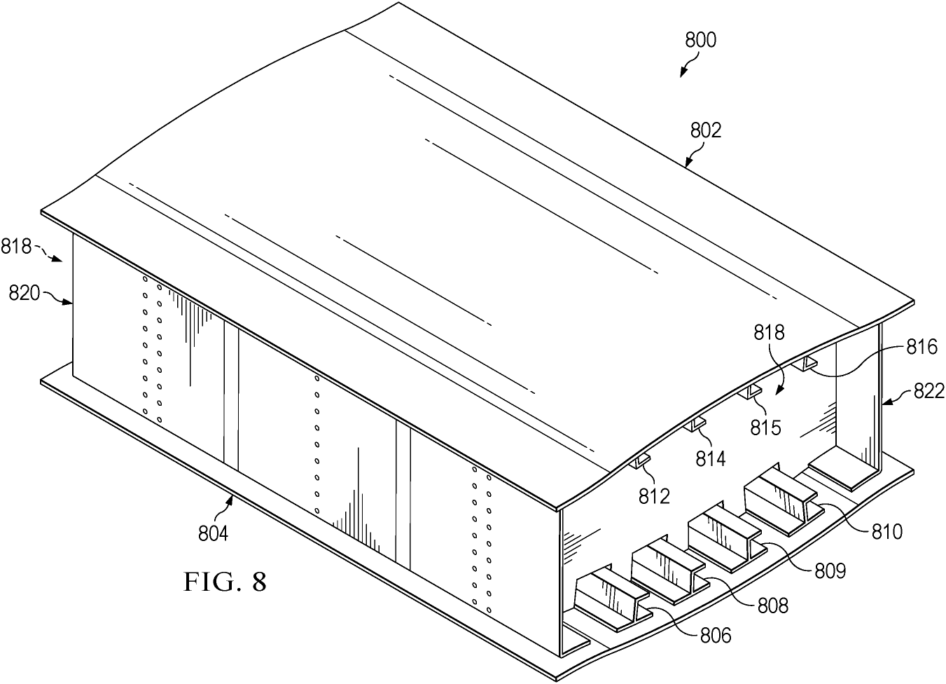

Turning now to FIG. 8, an illustration of an isometric view of a fuel tank of an aircraft is depicted in accordance with an illustrative embodiment. Fuel tank 800 can be an implementation of a fuel tank of aircraft 600 of FIG. 6. Fuel tank 800 is a physical implementation of fuel tank 706 of FIG. 7.

Fuel tank 800 comprises skin 802 and skin 804. Skin 802 and skin 804 form a cavity within a wing, such as wing 602 or wing 604 of aircraft 600. Stiffeners are connected to skin 802 and skin 804 to provide rigidity to skin 802 and skin 804. Stiffener 806, stiffener 808, stiffener 809, and stiffener 810 are connected to skin 804. Stiffener 812, stiffener 814, stiffener 815, and stiffener 816 are connected to skin 802.

Rib 818 is configured to be joined to skin 804. Rib 818 is configured with openings to accommodate stiffener 806, stiffener 808, stiffener 809, and stiffener 810 connected to skin 804 and stiffener 812, stiffener 814, stiffener 815, and stiffener 816 connected to skin 802.

During joining of rib 818 to skin 804, gaps can be present between rib 818 and skin 804. During joining of rib 818 to skin 802, gaps can be present between rib 818 and skin 802. To reduce or prevent gaps between rib 818 and skin 802, structural gap filler (not depicted) is provided between rib 818 and skin 802. To reduce or prevent gaps between rib 818 and skin 804, structural gap filler (not depicted) is provided between rib 818 and skin 804.

In some illustrative examples, structural gap filler (not depicted) is spread onto rib 818 prior to being joined to skin 802. In some illustrative examples, structural gap filler (not depicted) is spread onto skin 802 prior to being joined to rib 818.

In some illustrative examples, an out of tolerance gap is present between skin 802 and rib 818 after skin 802 and rib 818 are positioned relative to each other. In some illustrative examples, additional structural gap filler is injected between rib 818 and skin 802 to fill an out of tolerance gap after skin 802 and rib 818 are positioned relative to each other.

Spar 820 is configured to be joined to skin 802 and skin 804. Spar 822 is configured to be joined to skin 802 and skin 804. To reduce or prevent gaps between spar 820 and skin 802, structural gap filler (not depicted) is provided between spar 820 and skin 802. To reduce or prevent gaps between spar 820 and skin 804, structural gap filler (not depicted) is provided between spar 820 and skin 804.

To reduce or prevent gaps between spar 822 and skin 802, structural gap filler (not depicted) is provided between spar 822 and skin 802. To reduce or prevent gaps between spar 822 and skin 804, structural gap filler (not depicted) is provided between spar 822 and skin 804.

In some illustrative examples, an out of tolerance gap is present between skin 802 and spar 820 after skin 802 and spar 820 are positioned relative to each other. In some illustrative examples, additional structural gap filler is injected between spar 820 and skin 802 to fill an out of tolerance gap after skin 802 and spar 820 are positioned relative to each other. In some illustrative examples, additional structural gap filler is injected between spar 820 and skin 804 to fill an out of tolerance gap after skin 804 and spar 820 are positioned relative to each other.

In some illustrative examples, additional structural gap filler is injected between spar 822 and skin 802 to fill an out of tolerance gap after skin 802 and spar 822 are positioned relative to each other. In some illustrative examples, additional structural gap filler is injected between spar 822 and skin 804 to fill an out of tolerance gap after skin 804 and spar 822 are positioned relative to each other.

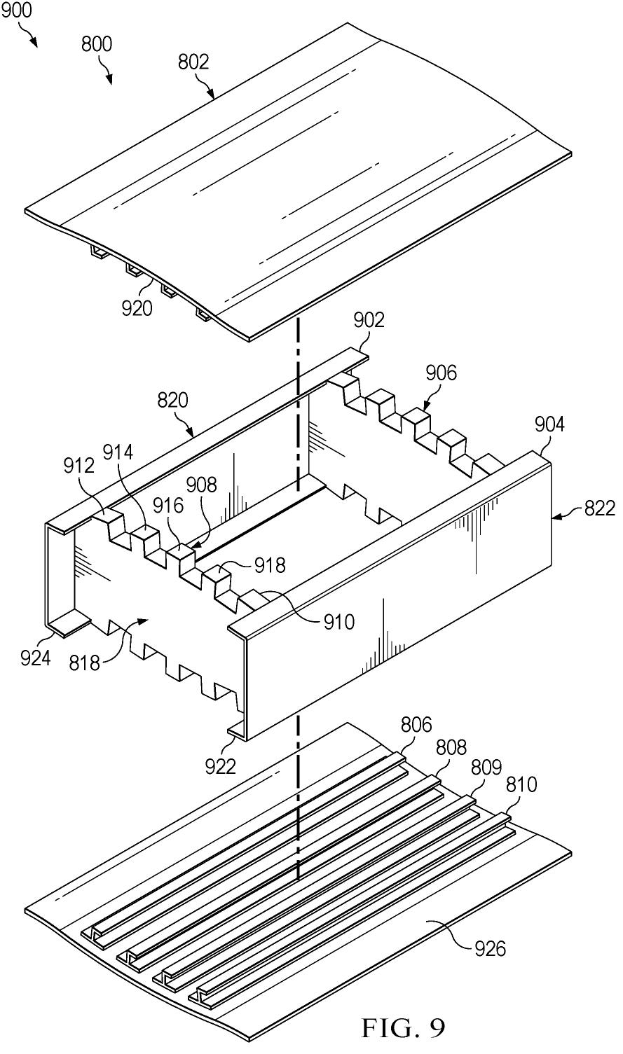

Turning now to FIG. 9, an illustration of a partially exploded view of a fuel tank of an aircraft is depicted in accordance with an illustrative embodiment. View 900 is a partially exploded view of fuel tank 800 of FIG. 8. In view 900, skin 802 and skin 804 with respective stiffeners are shown removed from spar 820, spar 822, and rib 818.

In view 900, flange 902 of spar 820 is visible. In view 900, flange 904 of spar 822 is visible. Flange 902 is configured to be joined to skin 802. Flange 904 is configured to be joined to skin 802.

In view 900, rib 906 is visible. Each of rib 818 and rib 906 are configured to be joined to skin 802 and skin 804. Rib 818 has edges 908 configured to be joined to skin 802. Edges 908 include edge 910, edge 912, edge 914, edge 916, and edge 918. Each of edges 908 is configured to contact skin 802 and accommodate respective stringers on skin 802.

A structural gap filler is used to reduce gaps between skin 802 and other components of fuel tank 800. For example, structural gap filler (not depicted) can be applied between skin 802 and spar 820. As another example, structural gap filler (not depicted) can be applied between skin 802 and spar 822.

Prior to assembly, a structural gap filler (not depicted) is spread onto at least one of surface 920 of skin 802 or flange 902. Prior to assembly, a structural gap filler (not depicted) is spread onto at least one of surface 920 of skin 802 or flange 904.

A structural gap filler (not depicted) can be used between portions of rib 818 and skin 802. A structural gap filler (not depicted) can be used between portions of rib 906 and skin 802.

For example, a structural gap filler (not depicted) is spread onto at least one of surface 920 of skin 802 or edge 910 of rib 818. As another example, a structural gap filler (not depicted) is spread onto at least one of surface 920 of skin 802 or edge 912 of rib 818. As another example, a structural gap filler (not depicted) is spread onto at least one of surface 920 of skin 802 or edge 914 of rib 818. Additionally, a structural gap filler (not depicted) can be spread onto at least one of surface 920 of skin 802 or edge 916 of rib 818. A structural gap filler (not depicted) can be spread onto at least one of surface 920 of skin 802 or edge 918 of rib 818.

In view 900, flange 922 of spar 822 is visible. In view 900, flange 924 of spar 820 is visible. Flange 922 is configured to be joined to skin 804. Flange 924 is configured to be joined to skin 804.

Prior to assembly, a structural gap filler (not depicted) is spread onto at least one of surface 926 of skin 804 or flange 922. Prior to assembly, a structural gap filler (not depicted) is spread onto at least one of surface 926 of skin 804 or flange 924.

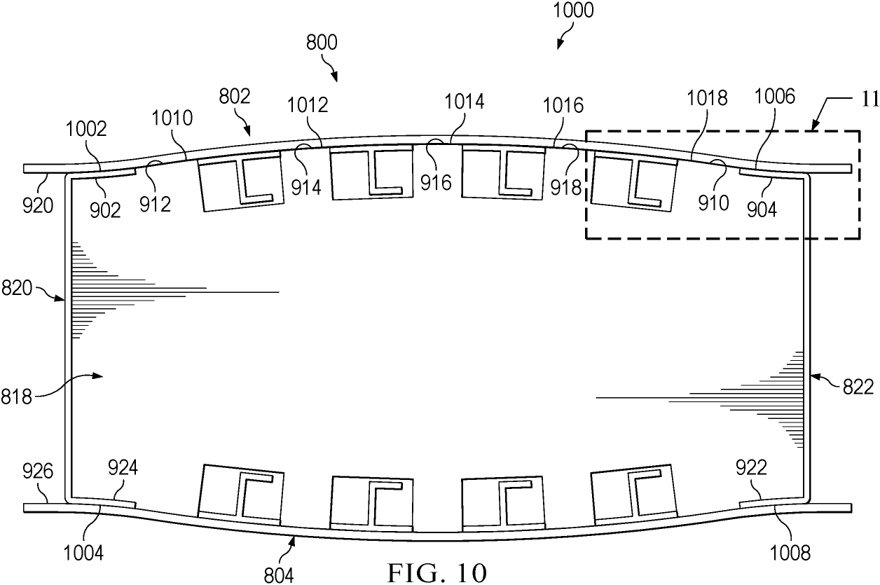

Turning now to FIG. 10, an illustration of a side view of a fuel tank of an aircraft is depicted in accordance with an illustrative embodiment. In view 1000, joints of fuel tank 800 are visible.

Joint 1002 is formed between flange 902 of spar 820 and skin 802. Joint 1004 is formed between flange 924 of spar 820 and skin 804. Joint 1006 is formed between flange 904 of spar 822 and skin 802. Joint 1008 is formed between flange 922 of spar 822 and skin 804.

A joint is also formed between rib 818 and skin 802. Surface 920 of skin 802 forms a joint with edge 910, edge 912, edge 914, edge 916, and edge 918. Joint 1010 is formed between edge 912 of rib 818 and surface 920 of skin 802. Joint 1012 is formed between edge 914 of rib 818 and surface 920 of skin 802. Joint 1014 is formed between edge 916 of rib 818 and surface 920 of skin 802. Joint 1016 is formed between edge 918 of rib 818 and surface 920 of skin 802. Joint 1018 is formed between edge 910 of rib 818 and surface 920 of skin 802.

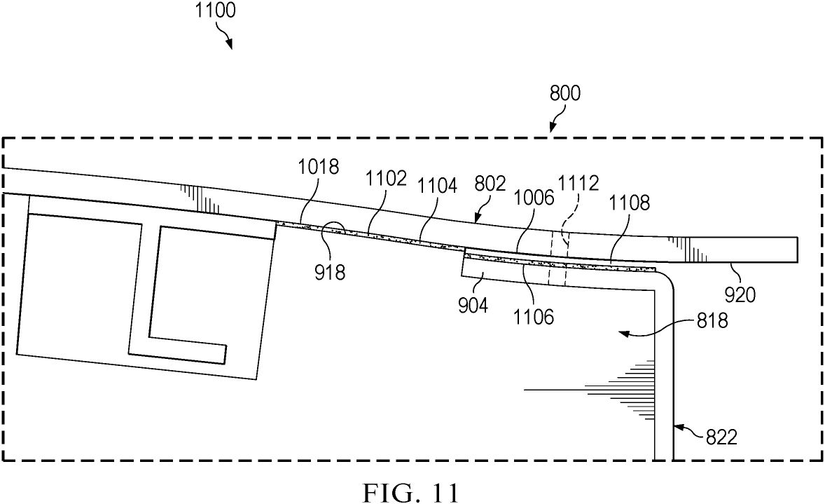

Turning now to FIG. 11, an illustration of a cross-sectional view of a portion of a fuel tank of an aircraft is depicted in accordance with an illustrative embodiment. View 1100 is a cross-sectional view of joint 1006 and joint 1018 of fuel tank 800. As depicted, joint 1018 between skin 802 and rib 818 comprises structural gap filler 1102. Structural gap filler 1102 fills space 1104 between skin 802 and rib 818. Structural gap filler 1102 was applied to one of rib 818 or skin 802 prior to positioning skin 802 and rib 818 relative to each other.

As depicted, joint 1006 between skin 802 and spar 822 comprises structural gap filler 1106. In some illustrative examples, structural gap filler 1102 and structural gap filler 1106 are the same material. In some illustrative examples, structural gap filler 1102 and structural gap filler 1106 are different materials.

Structural gap filler 1106 fills some of space 1108 between skin 802 and flange 904 of spar 822. Gap 1110 is present between structural gap filler 1106 and skin 802. Although structural gap filler 1106 is depicted as applied to rib 818, in some non-depicted illustrative examples, a gap can be present between structural gap filler 1106 and rib 818. In this illustrative example, gap 1110 is out of tolerance.

After determining gap 1110 is out of tolerance, an additional structural gap filler can be injected into gap 1110. In some illustrative examples, the additional gap filler (not depicted) can be the same as structural gap filler 1106. In some illustrative examples, the additional gap filler (not depicted) can be different from structural gap filler 1106. Hole 1112 is positioned over gap 1110. Additional gap filler can be injected through hole 1112 to fill or partially fill gap 1110.

In some illustrative examples, hole 1112 is a pilot hole for fasteners. In some illustrative examples, hole 1112 is drilled for injection of the additional gap filler.

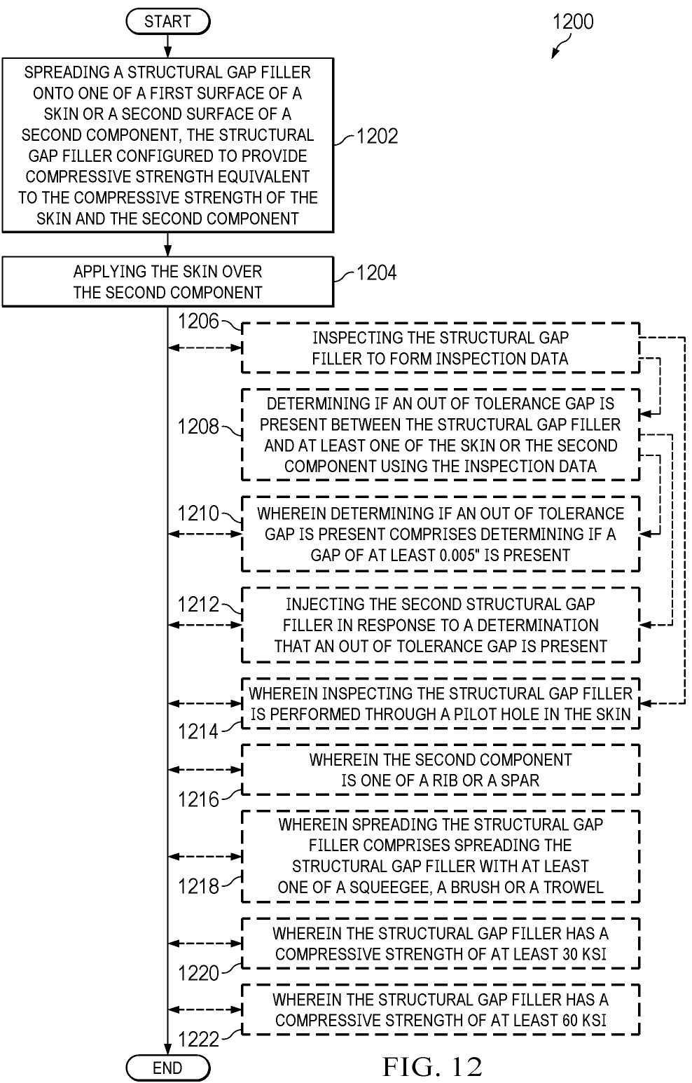

Turning now to FIG. 12, a flowchart of a method of forming a fuel tank in a wing of an aircraft is depicted in accordance with an illustrative embodiment. Method 1200 can be performed using liquid shim injection devices 100 of FIGS. 1-3. In some illustrative examples, assemblies 200 of FIGS. 1, 3, and 4 can be portions of fuel tank receiving the structural gap filler in method 1200. Method 1200 can be used to form a fuel tank of aircraft 600 of FIG. 6. Method 1200 can be used to form fuel tank 706 of FIG. 7. Method 1200 can be used to form fuel tank 800 of FIGS. 8-11.

Method 1200 spreads a structural gap filler onto one of a first surface of a skin or a second surface of a second component, the structural gap filler configured to provide compressive strength equivalent to the compressive strength of the skin and the second component (operation 1202). Method 1200 applies the skin over the second component (operation 1204). Afterwards method 1200 terminates.

In some illustrative examples, method 1200 inspects the structural gap filler to form inspection data (operation 1206). In some illustrative examples, the structural gap filler is inspected visually. In some illustrative examples, method determines if an out of tolerance gap is present between the structural gap filler and at least one of the skin or the second component using the inspection data (operation 1208).

In some illustrative examples, determining if an out of tolerance gap is present comprises determining if a gap of at least 0.005" is present (operation 1210). In some illustrative examples, the outer of tolerance gap is greater than 0.008 inches.

In some illustrative examples, the second structural gap filler is injected in response to a determination that an out of tolerance gap is present (operation 1212). In these illustrative examples, the second structural gap filler is injected to bring the out of tolerance gap into tolerance.

In some illustrative examples, inspecting the structural gap filler is performed through a hole in the skin (operation 1214). In some illustrative examples, the second structural gap filler is injected through the hole in the skin.

In some illustrative examples, the second component is one of a rib or a spar (operation 1216). In some illustrative examples, the structural gap filler is between a flange of the spar and the skin. In some illustrative examples, the structural gap filler is between an edge of the rib and the skin.

In some illustrative examples, spreading the structural gap filler comprises spreading the structural gap filler with at least one of a squeegee, a brush, or a trowel (operation 1218). In some illustrative examples, the structural gap filler is spread by an end effector having a spreading tool.

In some illustrative examples, the structural gap filler has a compressive strength of at least 30 ksi (operation 1220). In some illustrative examples, the structural gap filler having a compressive strength of at least 30 ksi can be used in a fuselage of an aircraft.

In some illustrative examples, the structural gap filler has a compressive strength of at least 60 ksi (operation 1222). In some illustrative examples, the structural gap filler having a compressive strength of at least 60 ksi can be used in a fuel tank of an aircraft.

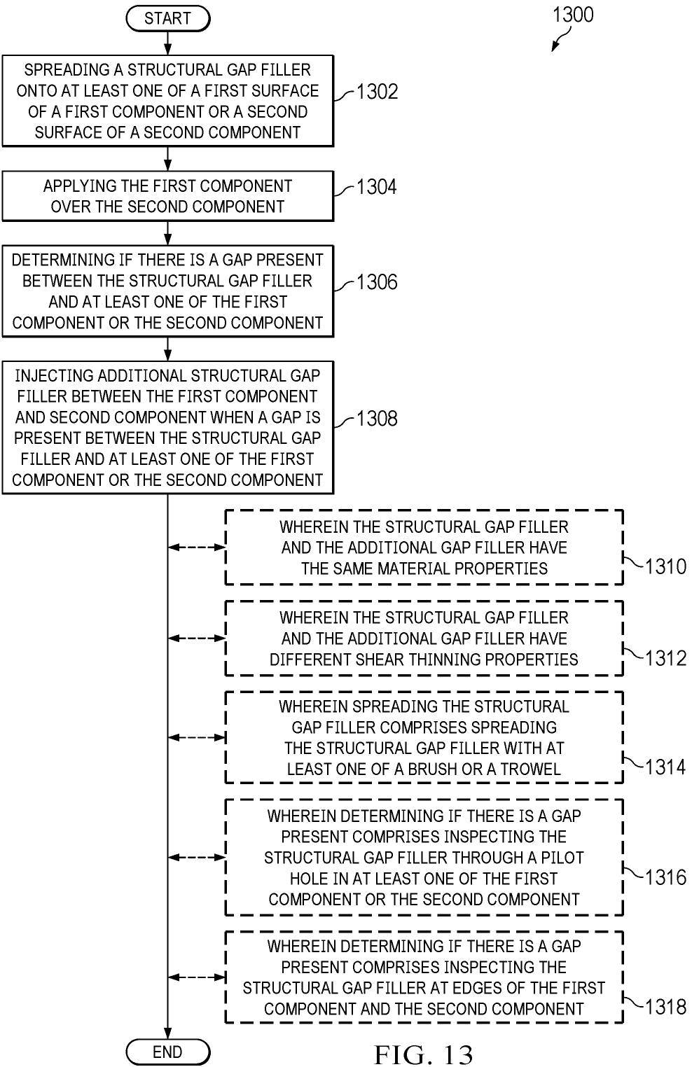

Turning now to FIG. 13, a flowchart of a method of forming a joint in an aircraft is depicted in accordance with an illustrative embodiment. Method 1300 can be performed using liquid shim injection devices 100 of FIGS. 1-3. In some illustrative examples, assemblies 200 of FIGS. 1, 3, and 4 can be portions of fuel tank receiving the structural gap filler in method 1300. Method 1300 can be used to form a joint of aircraft 600 of FIG. 6. Method 1300 can be used to form fuel tank 706 of FIG. 7. Method 1300 can be used to form fuel tank 800 of FIGS. 8-11.

Method 1300 spreads a structural gap filler onto at least one of a first surface of a first component or a second surface of a second component (operation 1302). Method 1300 applies the first component over the second component (operation 1304).

Method 1300 determines if there is a gap present between the structural gap filler and at least one of the first component or the second component (operation 1306). Method 1300 injects additional structural gap filler between the first component and second component when a gap is present between the structural gap filler and at least one of the first component or the second component (operation 1308). Afterwards, method 1300 terminates.

In some illustrative examples, the structural gap filler and the additional gap filler have the same material properties (operation 1310). In some illustrative examples, the structural gap filler and the additional gap filler have different shear thinning properties (operation 1312).

In some illustrative examples, spreading the structural gap filler comprises spreading the structural gap filler with at least one of a squeegee, a brush, or a trowel (operation 1314). In some illustrative examples, determining if there is a gap present comprises inspecting the structural gap filler through a hole in at least one of the first component or the second component (operation 1316). In some illustrative examples, determining if there is a gap present comprises inspecting the structural gap filler at edges of the first component and the second component (operation 1318).

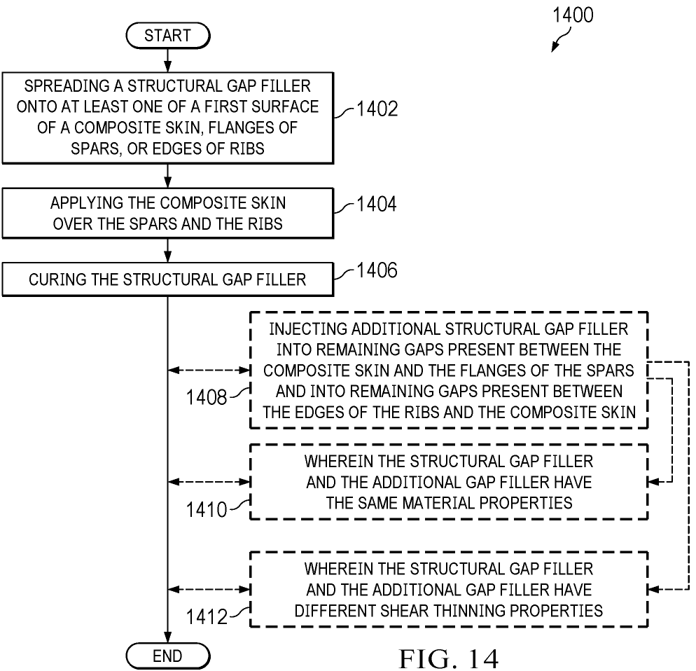

Turning now to FIG. 14, a flowchart of a method of forming an aircraft is depicted in accordance with an illustrative embodiment. Method 1400 can be used to form aircraft 600 of FIG. 6. Method 1400 can be used to form aircraft 702 of FIG. 7. Method 1400 can be used to form fuel tank 800 of FIGS. 8-11.

Method 1400 spreads a structural gap filler onto at least one of a first surface of a composite skin, flanges of spars, or edges of ribs (operation 1402). Method 1400 applies the composite skin over the spars and the ribs (operation 1404). Method 1400 cures the structural gap filler (operation 1406). Afterwards, method 1400 terminates.

In some illustrative examples, method 1400 injects additional structural gap filler into remaining gaps present between the composite skin and the flanges of the spars and into remaining gaps present between the edges of the ribs and the composite skin (operation 1408).

In some illustrative examples, the structural gap filler and the additional gap filler have the same material properties (operation 1410).

In some illustrative examples, the structural gap filler and the additional gap filler have different shear thinning properties (operation 1412).

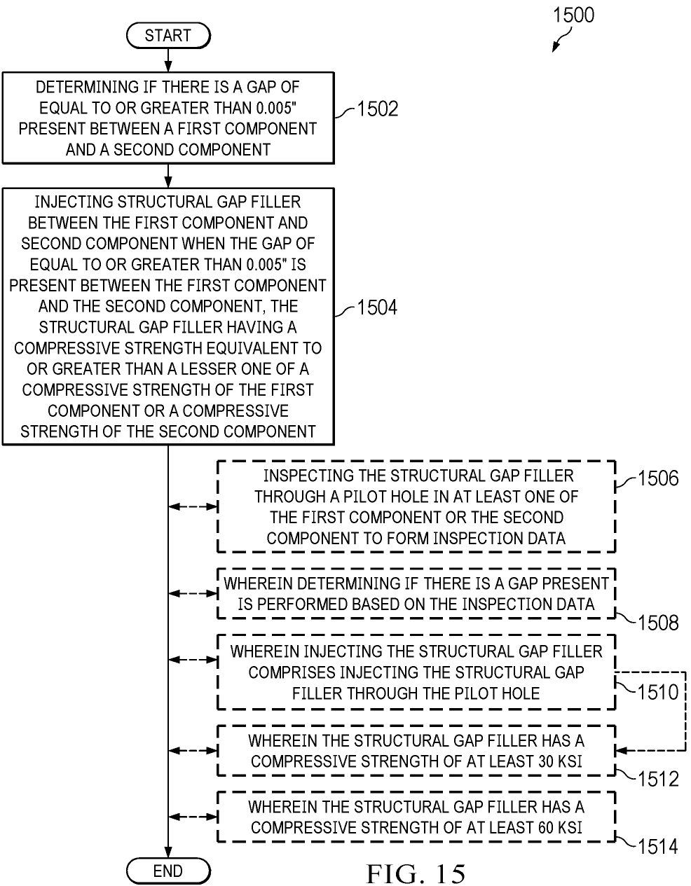

Turning now to FIG. 15, a flowchart of a method of filling a gap in an aircraft is depicted in accordance with an illustrative embodiment. Method 1500 can be used to fill a gap in aircraft 600 of FIG. 6. Method 1500 can be used to fill a gap in aircraft 702 of FIG. 7. Method 1500 can be used to fill a gap in a fuel tank of an aircraft, such as fuel tank 800 of FIGS. 8-11.

Method 1500 determines if there is a gap of equal to or greater than 0.005" present between a first component and a second component (operation 1502). Method 1500 injects structural gap filler between the first component and second component when the gap of equal to or greater than 0.005" is present between the first component and the second component, the structural gap filler having a compressive strength equivalent to or greater than a lesser one of a compressive strength of the first component or a compressive strength of the second component (operation 1504). Afterwards, method 1500 terminates.

In some illustrative examples, method 1500 inspects the structural gap filler through a hole in at least one of the first component or the second component to form inspection data (operation 1506). In some illustrative examples, determining if there is a gap present is performed based on the inspection data (operation 1508).

In some illustrative examples, injecting the structural gap filler comprises injecting the structural gap filler through the hole (operation 1510). In some illustrative examples, the structural gap filler has a compressive strength of at least 30 ksi (operation 1512). In some illustrative examples, the structural gap filler has a compressive strength of at least 60 ksi (operation 1514).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, any of operation 1206 through operation 1222 may be optional. For example, any of operation 1310 through operation 1318 may be optional. For example, any of operation 1408 through operation 1412 may be optional. For example, any of operation 1506 through operation 1514 may be optional.

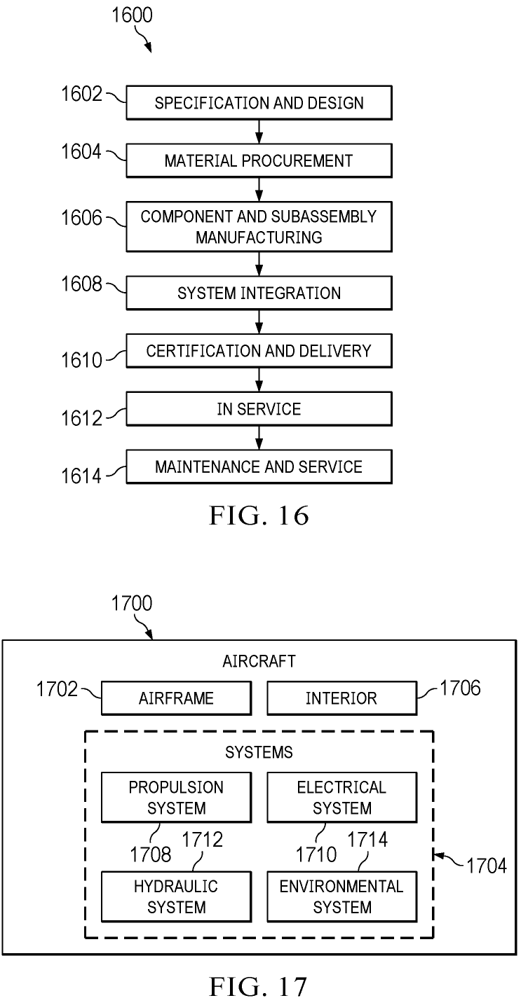

Illustrative embodiments of the present disclosure may be described in the context of aircraft manufacturing and service method 1600 as shown in FIG. 16 and aircraft 1700 as shown in FIG. 17. Turning first to FIG. 16, an illustration of an aircraft manufacturing and service method is depicted in accordance with an illustrative embodiment. During pre-production, aircraft manufacturing and service method 1600 may include specification and design 1602 of aircraft 1700 in FIG. 17 and material procurement 1604.

During production, component and subassembly manufacturing 1606 and system integration 1608 of aircraft 1700 takes place. Thereafter, aircraft 1700 may go through certification and delivery 1610 in order to be placed in service 1612. While in service 1612 by a customer, aircraft 1700 is scheduled for routine maintenance and service 1614, which may include modification, reconfiguration, refurbishment, or other maintenance and service.

Each of the processes of aircraft manufacturing and service method 1600 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 17, an illustration of an aircraft is depicted in which an illustrative embodiment may be implemented. In this example, aircraft 1700 is produced by aircraft manufacturing and service method 1600 of FIG. 16 and may include airframe 1702 with plurality of systems 1704 and interior 1706. Examples of systems 1704 include one or more of propulsion system 1708, electrical system 1710, hydraulic system 1712, and environmental system 1714. Any number of other systems may be included.

Apparatuses and methods embodied herein may be employed during at least one of the stages of aircraft manufacturing and service method 1600. One or more illustrative embodiments may be manufactured or used during at least one of component and subassembly manufacturing 1606, system integration 1608, in service 1612, or maintenance and service 1614 of FIG. 16.

A portion of airframe 1702 of aircraft 1700 can be formed by any of method 1200, method 1300, method 1400, or method 1500. Any of method 1200, method 1300, method 1400, or method 1500 can be performed during component and subassembly manufacturing 1606. Structural gap filler 712 can be used to form a composite structure during component and subassembly manufacturing 1606. A composite structure formed using any of method 1200, method 1300, method 1400, or method 1500 is present and utilized during in service 1612. Any of method 1200, method 1300, method 1400, or method 1500 can be performed during maintenance and service 1614 to form a replacement part.

The illustrative examples can reduce or eliminate in-tank sealing activities. By applying a structural gap filler configured to reduce or prevent leaks, gaps are reduced or eliminated, structural loading in a joint is enabled, and leaks are reduced or prevented. The illustrative examples can enable confined space fuel tank assembly for thin tanks. The illustrative examples can reduce or eliminate steps within the tank that would be otherwise undesirably difficult due to reach limitations.

Using a structural gap filler as a fay seal applied at tank skin closure can be an enabler for confined space work reduction or elimination. The structural gap filler can reduce manufacturing time and manufacturing cost for thin composite wing.

The illustrative examples allow for only structural liquid shim (SLS) epoxy material to seal the tank and fill the gaps in one step. In some illustrative examples, the structural gap filling material is applied as a fay seal between airplane members. The single application would fill the gaps between members and permanently seal the members to prevent fuel leakage and eliminate the polysulfide sealant usage for this application.

The illustrative examples can reduce or eliminate carbon fiber and fiberglass shimming in addition to polysulfide fay and fillet sealing for fuel tank leak prevention. The illustrative examples can reduce or eliminate in-tank sealing activity enabling confined space fuel tank assembly for thin tanks where reach limitations make it undesirably difficult to access the tank.

The illustrative examples provide a method to prevent fuel leaks in one easy step. The illustrative examples reduce or eliminate taking apart assemblies for gap management. By reducing or eliminating steps to take apart assemblies, the illustrative examples reduce at least one of manufacturing cost or manufacturing time. The illustrative examples enable gap filling without entering the closed tank after the skin has been put on the wing.

The illustrative examples eliminate or reduce measuring or manufacturing of shims and installation of shims into the structure during assembly. The illustrative examples eliminate or reduce carbon fiber reinforce polymer (CFRP) and Fiberglass shimming processes including measuring gaps, machining to exacting dimensions, and installation of shims. By reducing or eliminating shimming, the illustrative examples reduce at least one of manufacturing cost or manufacturing time. The illustrative examples can eliminate or reduce polysulfide sealant fay and fillet applications for leakage prevention. The illustrative examples can result in manufacturing time savings.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1-20. (canceled)

21. A method of forming a fuel tank in a wing of an aircraft, the method comprising:
spreading a structural gap filler onto one of a first surface of a skin or a second surface of a second component, the structural gap filler configured to provide compression strength equivalent to the compression strength of the skin and the second component; and
applying the skin over the second component.

22. The method of claim 21 further comprising:
inspecting the structural gap filler; and
determining if an out of tolerance gap is present between the structural gap filler and at least one of the skin or the second component.

23. The method of claim 22, wherein determining if an out of tolerance gap is present comprises determining if a gap of at least 0.005" is present.

24. The method of claim 22 further comprising:
injecting a second structural gap filler in response to a determination that an out of tolerance gap is present.

25. The method of claim 22, wherein inspecting the structural gap filler is performed through a hole in the skin.

26. The method of claim 21, wherein the second component is one of a rib or a spar.

27. The method of claim 21, wherein spreading the structural gap filler comprises spreading the structural gap filler with at least one of a squeegee, a brush, or a trowel.

28. The method of claim 21, wherein the structural gap filler has a compressive strength of at least 30 ksi.

29. The method of claim 21, wherein the structural gap filler has a compressive strength of at least 60 ksi.

30. A method of forming a joint in an aircraft, the method comprising:
spreading a structural gap filler onto at least one of a first surface of a first component or a second surface of a second component;
applying the first component over the second component;
determining if there is a gap present between the structural gap filler and at least one of the first component or the second component; and
injecting additional structural gap filler between the first component and second component when a gap is present between the structural gap filler and at least one of the first component or the second component.

31. The method of claim 30, wherein the structural gap filler and the additional gap filler have the same material properties.

32. The method of claim 30, wherein the structural gap filler and the additional gap filler have different shear thinning properties.

33. The method of claim 30, wherein spreading the structural gap filler comprises spreading the structural gap filler with at least one of a squeegee, a brush, or a trowel.

34. The method of claim 30, wherein determining if there is a gap present comprises inspecting the structural gap filler through a hole in at least one of the first component or the second component.

35. The method of claim 30, wherein determining if there is a gap present comprises inspecting the structural gap filler at edges of the first component and the second component.

36. A method of forming an aircraft, the method comprising:
spreading a structural gap filler onto at least one of a first surface of a composite skin, flanges of spars, or edges of ribs;
applying the composite skin over the spars and the ribs; and
curing the structural gap filler.

37. The method of claim 36 further comprising:
injecting additional structural gap filler into remaining gaps present between the composite skin and the flanges of the spars and into remaining gaps present between the edges of the ribs and the composite skin.

38. The method of claim 37, wherein the structural gap filler and the additional gap filler have the same material properties.

39. The method of claim 37, wherein the structural gap filler and the additional gap filler have different shear thinning properties.

40. A method of filling a gap in an aircraft, the method comprising:
determining if there is a gap of equal to or greater than 0.005" present between a first component and a second component; and
injecting structural gap filler between the first component and second component when the gap of equal to or greater than 0.005" is present between the first component and the second component, the structural gap filler having a compressive strength equivalent to or greater than a lesser one of a compressive strength of the first component or a compressive strength of the second component.

41. The method of claim 40 further comprising:
inspecting the structural gap filler through a hole in at least one of the first component or the second component to form inspection data; and
wherein determining if there is a gap present is performed based on the inspection data.

42. The method of claim 41, wherein injecting the structural gap filler comprises injecting the structural gap filler through the hole.

43-45. (canceled)
